(19) United States
(12) Patent Application Publication
(10) Pub. No.: US 2009/0112701 A1
(43) Pub. Date: Apr. 30, 2009

(54) System and method for implementing advertising in an online social network

(75) Inventors: Andrew Martin Turpin, Astoria, NY (US); Jeffrey B. Katz, New York, NY (US); Mirko Meier, Brooklyn, NY (US)

Correspondence Address: MICHAELSON & ASSOCIATES, P.O. BOX 8489, RED BANK, NJ, 07701-8489, US

(73) Assignee: Enliven Marketing Technologies Corporation, New York, NY (US)

(21) Appl. No.: 12/283,039

(22) Filed: Sep. 9, 2008

Related U.S. Application Data
(62) Division of application No. 12/011,880, filed on Jan. 30, 2008.
(60) Provisional application No. 60/898,808, filed on Feb. 1, 2007.

(51) Int. Cl. G06Q 10/00; G06Q 30/00

(52) U.S. Cl. 705/10; 705/14

(57) ABSTRACT

A system and method for integrating analytics data of user profiles within a social network with targeted ad campaigns. The system includes an advertisement targeting system that obtains analytics data of user profiles and utilizes the data to filter through the user profiles to select desired user profiles for delivery of advertisements targeted to the interests and personality of the desired user profiles. Utilization of the analytics data includes generating a social rank of each user profile relevant to other user profiles in the social network. An advertising marketplace is implemented for use by ad marketers to purchase advertisement rights on a user profile webpage, to filter through user profiles in a social network for select user profiles with desired analytics data, and to generate advertisement campaigns targeted to the selected user profiles within a social network.

### CLAIM TO PRIORITY

This application claims the benefit of our co-pending United States patent application entitled “SYSTEM AND METHOD FOR IMPLEMENTING ADVERTISING IN AN ONLINE SOCIAL NETWORK” filed Jan. 30, 2008 and assigned Ser. No. 12/011,880, which is incorporated by reference herein.

### BACKGROUND OF THE DISCLOSURE

1. Field of the Invention

The invention relates to a system and method for providing advertisements to users in an online social network. Specifically, the invention relates to providing targeted advertisements to each user based upon the user's profile within the online social network. The invention also relates to a system and method for providing an advertisement marketplace to marketers where each marketer can select user profiles to target and buy advertising rights to the selected user profiles to deliver targeted advertisements.

2. Description of the Prior Art

The online social network advertising market is growing at an exponential rate. Potential advertisement spending for online social networks may reach approximately $2.2 billion in 2010, which would be an increase from $350 million in 2006. The $2.2 billion amount represents about 8.5 percent of the United States (U.S.) market for online advertisements. Thus, by 2010, spending for advertisements in online social networks should account for approximately 8.5 percent of a possible $25.2 billion U.S. online advertising market.

One example of a social network, MYSPACE™ provided by News Corporation, has approximately 126 million members. MYSPACE reached approximately $525 million in advertisement revenue in 2007, up from about $180 million in 2006. Ad revenue for other online social networking sites, such as, FACEBOOK, provided by Facebook, Inc., BEBO, provided by Bebo, Inc., and FRIENDSTER, provided by Friendster, Inc., has the potential to reach approximately $200 million in advertisement revenue for each social network website in 2007.

Additionally, U.S. marketers may not be the only marketers to test the social networking waters. International online advertisement spending is expected to increase as established players launch networks in other countries and languages. EMARKETER, an Internet market research and trend analysis website provided by eMarketer Inc., estimates that worldwide social network ad spending will increase to approximately $1.1 billion in 2007, up from approximately $445 million in 2006. EMARKETER further estimates such international advertisement spending to increase to approximately $2.8 billion in 2010. Accordingly, the market for ads served to users of online social networks is rapidly growing.

Unfortunately, social networks face certain challenges when it comes to drawing marketing dollars. For one, quantifying the results of advertisement campaigns in online social networks remains difficult, especially for viral ad campaigns, which are ad campaigns that encourage viewers of the campaign to pass along the marketing message voluntarily to others, such as, by word of mouth. Additionally, methods for targeting campaigns to specific users or user profiles within a social network remain few.

Thus, a need exists in the art for a solution to target advertising campaigns to specific users within a social network in order for the social network to increase the value of the social network's advertisement space and for the ad marketer to achieve the most efficient ad campaign for its money.

### SUMMARY OF THE INVENTION

Advantageously the present invention overcomes the deficiencies in the art by targeting relevant advertising to user profiles in an online social network. The invention also provides a self-serve marketplace where advertising marketers can select user profiles in a social network for delivery of targeted advertisements to the user profiles. The marketplace also allows the marketers to generate advertisement campaigns to deliver to user profiles in a social network. The present invention also delivers targeted advertising to users as the users navigate to non-social network websites across the Internet.

In accordance with the present invention, analytics data of user profiles within a social network are integrated by the inventive system and method, with targeted ad campaigns. The system includes an advertisement targeting system that obtains analytics data of user profiles and utilizes the data to filter through the user profiles to select desired user profiles for delivery of advertisements targeted to interests and personality of the desired user profiles.

The system applies one or more filters to the user profiles, including a social rank filter and a psychographic filter. In an embodiment of the present invention, a social rank is determined for a user profile through use of available analytics data to compute a social rank value assigned to the user profile, where the social rank is reflective of popularity and influence of the user profile relative to other user profiles within the social network. Advertisements displayed on user profile webpages that are popular among other user profiles and/or that influence purchasing decisions of other user profiles potentially receive more user activity than advertisements to unpopular or non-influential user profiles.

Another embodiment of the present invention categorizes user profiles by psychographic attributes including manipulating the analytics data and other information available from the webpage of a user profile in a social network to determine lifestyle, values, and behavioral characteristics of the user profile, for delivery of targeted advertisements based on such characteristics.

A further embodiment of the present invention includes a system that implements an advertising marketplace to ad marketers for purchasing access to advertisement space on a user profile webpage in a social network, filtering through user profiles in a social network to select user profiles with desired analytics data, and generating advertisement campaigns targeted to the selected user profiles within a social network.

In an additional embodiment of the present invention, analytics data associated with a user's activity on non-social network webpages is obtained and then utilized to generate targeted advertisements that are to be delivered to the user while the user visits a non-social network webpage.

### BRIEF DESCRIPTION OF THE DRAWINGS

The teachings of the present invention can be readily understood by considering the following detailed description in conjunction with the accompanying drawings, in which:

FIG. 1 depicts system 100 for integrating analytics data from user profiles within an online social network with targeted advertisement campaigns;

FIG. 2 depicts inventive filtering and targeting application 112 as shown in FIG. 1;

FIG. 3 depicts inventive process 300 for determining social rank values for a plurality of user profiles;

FIG. 4 depicts inventive process 400 for generating psychographic categories and assigning the psychographic categories to user profiles within a social network;

FIG. 5 depicts inventive system 500 for selecting and purchasing advertising rights to user profiles in a social network, and for creating targeted advertisement campaigns to be delivered to the user profiles;

FIGS. 6-20 each depicts graphical user interfaces related to the system shown in FIG. 5;

FIG. 21 depicts an illustrative screenshot of a non-social network website;

FIG. 22 depicts analytics data available from the non-social network website shown in FIG. 21;

FIGS. 23-24 each depicts a graphical user interface of a system for purchasing advertising rights to users of the non-social network website shown in FIG. 21, in accordance with an embodiment of the present invention;

FIGS. 25-26 each depict a graphical illustration of grouping socially ranked user profiles related to the inventive process shown in FIG. 3.

To facilitate understanding, identical reference numerals have been used, where possible, to designate similar elements that are common to the figures.

### DETAILED DESCRIPTION

After considering the following description, those skilled in the art will clearly realize that the teachings of this invention can be readily utilized not only for creating targeted advertisements for users in an online social network, but also for creating targeted advertisements for users of any online websites, including non-social network websites.

Broadly speaking, in accordance with the inventive teachings, integrating analytics data obtained from one or more user profiles in an online social network with a targeted advertising campaign allows an marketer to optimize advertising to a targeted audience. Further, analytics data of user activity on a non-social network website also can be utilized to create advertisements to target users who visit the non-social network websites.

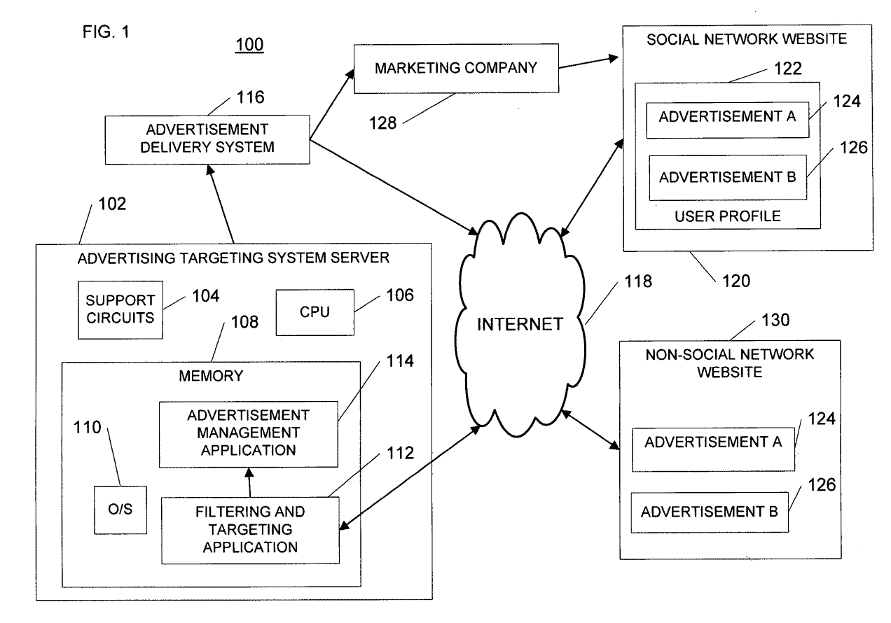

FIG. 1 depicts a system for integrating analytics data from a user profile in a social network with an advertising campaign. System 100 comprises advertising targeting system server 102, which includes support circuits 104, central processing unit (CPU) 106, and memory 108. Support circuits 104 are well known and comprise power supplies, clocks, input/output interface circuitry, and the like. Memory 108 comprises any random access memory, read only memory, removable disk memory, flash memory, and various combinations of these types of memory. Memory 108 is sometimes referred to as main memory and may in part be used as cache memory or buffer memory. Memory 108 stores various software packages and components, such as operating system (O/S) 110 and multiple software applications, including filtering and targeting application 112, and advertisement management application 114. System 100 also includes advertising delivery system 116.

To create a targeted advertising campaign, ad targeting system server 102 obtains analytics data associated with a plurality of user profiles, including user profile 122, from social network website 120 via the Internet 118. Analytics data is obtained by searching user profile 122 for certain attributes and information that describe the online activity of the owner of user profile 122, and the performance of the owner of user profile 122 within social network 120. Once the analytics data is obtained, the data is processed by filtering and targeting application 112 by applying filters specified by marketer 128 of a specific advertisement campaign to the analytics data to select one or more user profiles out of all of the available user profiles, where the each of the selected user profiles contain desired attributes by marketer 128 for the specific ad campaign. Processing of the user profiles includes determining a social rank of each user profile among the other user profiles in social network 120, wherein the social rank becomes a means for filtering through all of the user profiles in selecting desired user profiles to be served the marketer's ad campaign.

Once the desired user profiles have been selected, filtering and targeting application 112 transmits the selected user profiles to advertisement management application 114, which determines what type of advertisement campaign would be of the most interest to the selected user profiles, and what types of ads should be included in the advertisement campaign. Ad management application 114 then creates a targeted advertisement campaign to be delivered to each of the selected user profile owners, using ad creatives and campaign rules provided by marketer 128. The processes implemented by applications 112 and 114 will be discussed in detail below.

Once the targeted advertisement campaign is created, the campaign is transmitted to advertisement delivery system 116 for delivery of the ad campaign to a user, where the ad campaign will be displayed on a profile webpage associated with each selected user profile, such as advertisements A 124 and B 126 to be displayed on the webpage of user profile 122. Advertisements A 124 and B 126 may be delivered via Internet 118, as shown in FIG. 1, may be delivered directly to marketer 128 for delivery to the webpage of user profile 122, or to a third party (not shown) for independent delivery. Depending on the type of medium the user profile webpage is displayed upon, ad delivery system 116 may include one or more of the following types of systems for advertising: online search engine advertising for displaying ads when a user performs an online search, website advertising including text and display advertisements, such as, for example, banner advertisements and newsfeeds, mobile advertising for delivering ads to mobile devices, such as delivery of text messages to cellular phones and the like, kiosk advertising for delivering ads to electronic kiosks within retail establishments, electronic billboard advertising, electronic stadium advertising, electronic storefront advertising, online in-game advertising, and holographic advertising. Ad delivery system 116 can deliver ads using a peer-to-peer content delivery network, a non-peer content delivery network, for example, AKAMAI, provided by Akamai Technologies, Inc., and an internal content delivery network, such as a proprietary delivery network.

Another aspect of the embodiment includes advertising targeting system 102 obtaining analytics data from non-social network website 130, such as news websites, sports websites, search engines, and the like, that is visited by owner of user profile 122, and creating advertisements for display on non-social network website 130 based on the online activity of the owner of user profile 122. For example, the owner of user profile 122 in social network website 120 can visit non-social network website 130, such as a news website. Advertisement targeting system 102 can deliver targeted advertisements to the owner of user profile 122 while the owner visits the news website, as shown by advertisements A 124 and B 126 displayed on non-social network website 130. Thus, advertisement targeting system 112 can track the owner of user profile 122 while the owner navigates Internet 118 to deliver ads to the owner of user profile 122 at any time.

Yet another aspect of the embodiment includes ad targeting system 102 tracking the activity of the owner of user profile 122 while the owner navigates the Internet 118 at large, to deliver targeted advertisements to the owner of user profile 122 while the owner views any website.

The processes underlying filtering and targeting application 112 and advertisement management application 114 for utilizing the analytics data from user profile 122 to create advertisement campaigns are discussed in detail below.

To integrate user profile analytics data with a targeted advertisement campaign, the desired user profiles must be filtered from all of the user profiles available within an online social network. In one embodiment of the present invention, a marketer, such as marketer 128 (see FIG. 1), provides instructions regarding one or more types of user profiles marketer 128 wishes to advertise to. The guidelines are inputted into filtering and targeting application 112. An example of analytics data associated with a user profile is provided in Table 1 for a User Profile A, John Doe, within an online social network.

TABLE 1
User Profile A: John Doe

PROFILE
Page Views: 2,193
Unique Page Views: 450
Interaction Rate: 147%
Time/Page View: 52 Seconds
Ad CTR: .039%
PROFILE ACTIVITY
Friends Added: 32
Groups Added: 6
Wall Posts Added: 5
Networks Added: 4
Photos Added: 3
Photo Tags Added: 7
FRIENDS
Friends: 450
Friends of Friends: 5,345
Average Friend Rank: 4
Average Friend IR: 80%
Average Friend Time/Page: 0:9
GROUPS
Groups: 20
Quality of Groups: 3
Interactive:
EVENTS
Events: 6
Quality of Events: 5
NETWORKS
Networks: 19
People in Networks: 2,392,043
INTERESTS
Interests: 12
Sports: Yes (1)
Movies: Yes (9)

The analytics data in Table 1 is grouped by “attributes” such as “Profile,” “Friends,” and the like, where the attributes provide marketers with the best information regarding the online activity in the social network by John Doe in order to determine what advertisements would be of the most interest to John Doe.

The attributes include, but are not limited to, “Profile” data defined as data describing the actions of other users within a social network who visit and view John Doe's profile within the social network, as listed in the first column of Table 1. “Profile” data illustratively includes “Page Views” representing a number of users within the social network who have viewed John Doe's profile, “Interaction Rate” which measures how often other social network users visit and view John Doe's profile within a given time period, and “Ad CTR” (Advertisement Click-Thru-Rate) which is a value representing a number of times a social network user has clicked on an advertisement displayed on John Doe's profile webpage compared to a total number of advertisements displayed on John Doe's profile webpage within a set time period.

Additional attributes from Table 1 include “Profile Activity” data as listed in the first column of Table 1, which here constitutes data gathered from online activity performed by John Doe within the social network. “Profile Activity” data illustratively includes “Friends Added” representing a number of other social network users whom John Doe has selected to be a “friend” within a specified time period, such as, within the last month, “Groups Added” representing a number of social groups within the social network added by John Doe to his profile within a specified time period, “Networks Added” representing a number of outside social networks added to John Doe's profile, such as, for example, other online social networks, educational networks, and company networks, within a specific time period, and “Photos Added” representing a number of photos posted on John Doe's profile within a specified time period.

Other attributes from Table 1 include information about other social network users who John Doe considers to be his friends. For example, the “Friends” data located in the second column of Table 1 illustratively includes a total number of friends that John Doe has added to his profile, and the “Average Friend (Interaction Rate) IR” which is how often John Doe interacts with his designated “friends” within the social network. The second column of Table 2 also lists data associated with different social groups John Doe belongs to within the social network, as shown in the “Groups” data. The “Groups” data illustratively includes a total amount of social groups John Doe belongs to, and how often John Doe interacts with the social groups.

Additional attributes available from John Doe's profile in the social network are in the third column of Table 1. These attributes include, for example, “Events” which provides information regarding events that John Doe has participated in through the social network, “Networks” including information regarding other online social networks John Doe belongs to, and “Interests” including information regarding different interests John Doe has listed on his profile, such as what type of sports he likes, and his favorite type of movie.

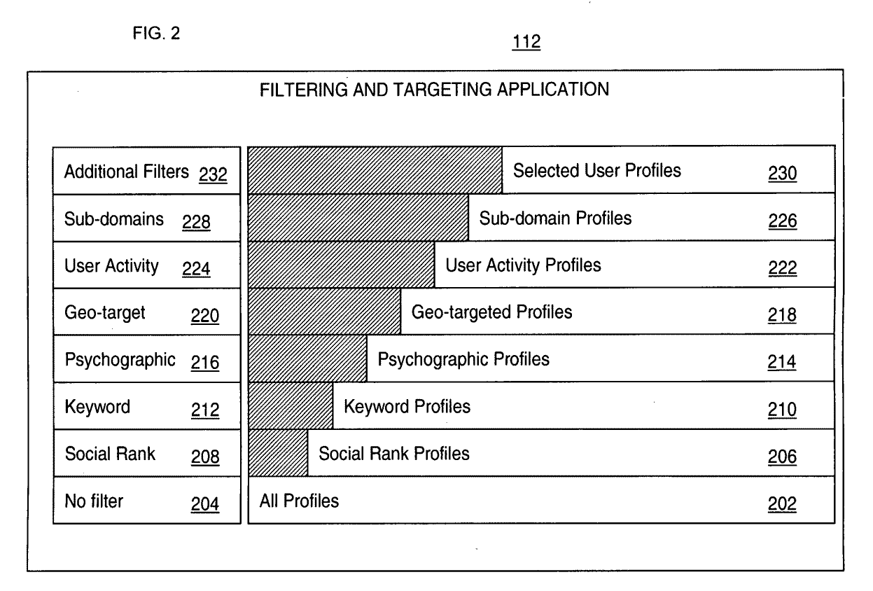

When the marketer provides instructions regarding the attributes and associated attribute data that a desired group of user profiles should contain, a filtering and targeting application, such as filtering and targeting application 112 (see FIG. 1), incorporates the instructions into a process for filtering through all of the user profiles to select a group of user profiles having the desired attributes in accordance to the marketer's needs. FIG. 2 depicts the filtering process applied by filtering and targeting application 112 to the attribute data obtained from user profiles within a social network, such as user profile 122 from the social network website 120 (see FIG. 1).

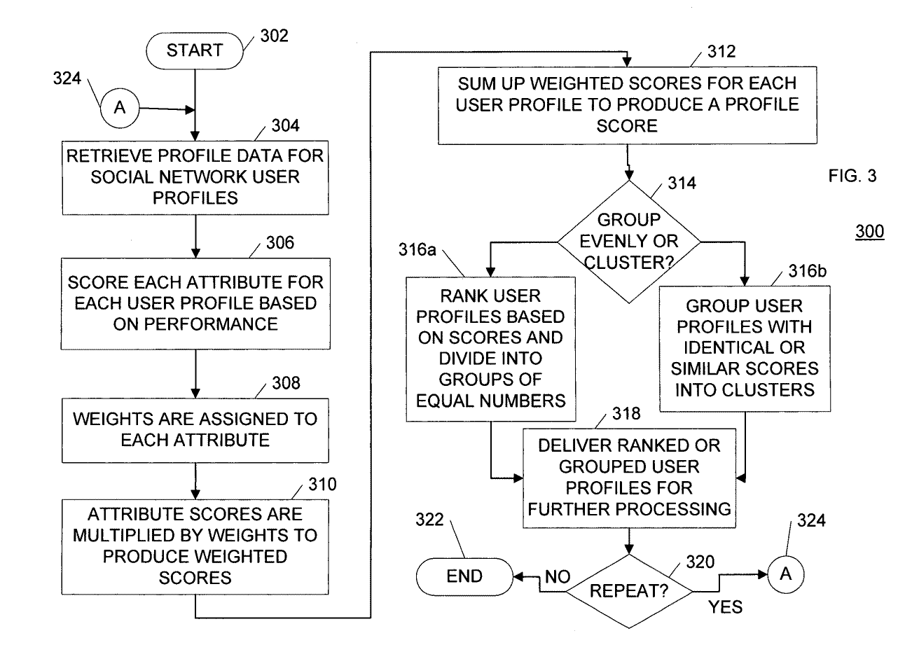

In FIG. 2, analytics data for all of the user profiles is entered into filtering and targeting application 112, shown at 202, with no filter yet applied, shown at 204. Filtering and targeting application 112 applies the marketer's guidelines regarding the attributes of each user profile the marketer wishes to target, and applies social rank filter 208 to select user profiles with a specific social rank value or range of social rank values. The social rank value is a perceived value of a user profile relative to other user profiles in the social network. Filtering and targeting application 112 applies social rank filter 208 to all of user profiles, shown at 202, by searching through the attribute data obtained for each user profile 202 and removing user profiles with undesirable social rank values from the total group of user profiles. Application of social rank filter 208 generates social rank profile group 206. Generating the social rank value for a user profile is described in detail below with respect to FIG. 3.

Next, the marketer wishes to target users who have certain keywords in their associated user profiles. Filtering and targeting application 112 then applies keyword filter 212 to social rank profiles 206, wherein keywords specified by the marketer are searched for in each of the social rank profiles 206. User profiles with each of the keywords are grouped together as keyword profiles 210.

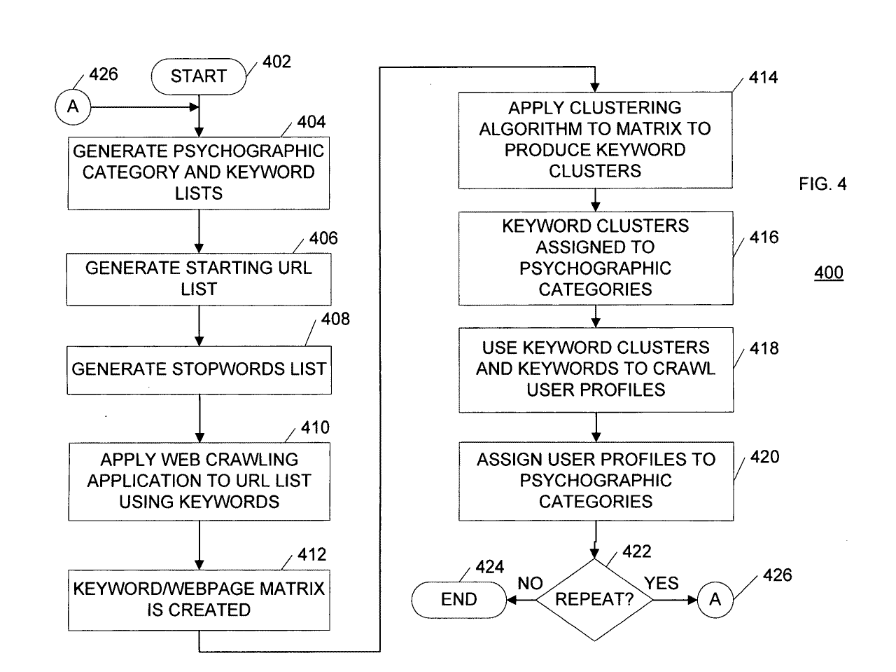

The marketer also wishes to target user profiles with specific psychographic attributes in their profiles. Psychographic attributes include analytics data relating to the personality, values, attitudes, interests and lifestyles of a user. For example, the marketer may desire to target user profiles that are outgoing, socially active, like outdoor sports and work nighttime jobs. Given the guideline of wanting user profiles with certain psychographic attributes, filtering and targeting application 112 applies psychographic filter 216 to keyword profiles 210 to remove user profiles that do not have the desired psychographic attributes, creating psychygraphic profiles 214. Psychographic filter will be discussed in detail with respect to FIG. 4.

Continuing, the marketer specifies that only user profiles in certain locations are desired, for example, profiles within a certain state. Filtering and targeting application 112 applies geo-target filter 220 to psychographic profiles 214 to remove users that do not fall within the geographic location(s) specified, leaving geo-targeted profiles 218.

Next, the marketer specifies that users with certain online activity are desired, for example, users that log in to their profile a certain number of times per day. Given this guideline, filtering and targeting application 112 applies user activity filter 224 to geo-targeted profiles 218 to produce user activity profiles 222.

The marketer also desires to target users with specific sub-domain attributes, for example, a type of company a user works for, an education level of a user, and a college a user has attended. Entering these guidelines, filtering and targeting application 112 applies sub-domain filter 228 to user activity profiles 222 and narrows the group of profiles further to sub-domain profiles 226.

The marketer also provides any additional guidelines, for example, certain demographics and behavioral attributes. Filtering and targeting application 112 applies additional filters 232 to sub-domain profiles 226 to produce the final group of selected user profiles 230 for the marketer.

Although FIG. 2 describes specific filters applied to the user profiles, other filters available to marketers can be used instead. Further, such filters also can be applied in different manners. For example, a marketer may wish to apply social rank filter 208 to target users within a certain range of social rank values, to apply keyword filter 212 to target user profiles with a specific percentage of certain keywords, and to apply geo-target filter 220 to target users within a specified range around a given location or within a certain part of a country.

As shown in FIG. 2, a social rank filter, such as social rank filter, may be applied to determine a group of user profiles having a certain social rank relevant to other user profiles within the social network. User profiles with a higher social rank than other user profiles may be desired by a marketer who wishes to target ad campaigns to such profiles. For example, a marketer may wish to target an ad campaign to users that heavily influence the consumer purchasing decisions of other users. Determining which users are influencers over others involves utilizing the attribute data available from each user profile to determine a social rank of each user profile. FIG. 3 depicts the process flow for determining the social rank of a user profile; the steps shown need not necessarily occur in the order described with some steps possibly occurring essentially simultaneously.

Process 300 begins at step 302 and proceeds to step 304 where an advertising targeting system, such as advertising targeting system 102 (see FIG. 1) obtains attribute data from user profiles within a social network, such as the user profile 122. Each user profile within a social network contains attribute data, such as the data provided in Table 1 above, which can be analyzed to determine the interests of the user profile as well as the influence of a user profile over other user profiles. At step 304, advertising targeting system 102 uses a filtering and targeting application, such as application 112 (see FIG. 1) to crawl through individual user profiles within a social network, and gather the attribute data. Filtering and targeting application 112 may gather analytics data from a group of user profiles within an online social network, or from all of the user profiles within the social network, as determined previously by the marketer.

To better comprehend process 300, Tables 2 through 7 below are used as examples of the data flow through steps in process 300. Beginning at step 302, process 300 proceeds to step 304 where filtering and targeting application 112 obtains attribute data for multiple user profiles in a social network. Table 3 is an example of attribute data collected from a selection of ten arbitrary user profiles, Profiles 1 through 10, where the data was gathered from each user profile's online activity in the social network over the course of a month.

TABLE 2
Analytics Data for Ten User Profiles

| | Profiles | | | | |
|---|---|---|---|---|---|
| Monthly Data | 1 | 2 | 3 | 4 | 5 |
| Page Views | 1249 | 593 | 111 | 111 | 234 |
| Unique Page Views | 450 | 200 | 21 | 56 | 123 |
| Interaction Rate (CTR) | 150% | 78% | 90% | 44% | 147% |
| Time/Page View | 10.20 | 4.20 | 2.87 | 3.87 | 4.87 |
| Ad CTR on Profile | 1.00% | 0.90% | 0.80% | 0.02% | 0.03% |
| Friends Added | 64 | 15 | 2 | 43 | 32 |
| Groups Added | 9 | 6 | 1 | 4 | 2 |
| Wall Posts Added | 12 | 9 | 5 | 5 | 9 |
| Networks Added | 13 | 8 | 3 | 4 | 5 |
| Photos Added | 938 | 3 | 3 | 365 | 34 |
| Photo Tages Added | 230 | 2 | 7 | 32 | 24 |
| Friends | 1972 | 450 | 23 | 789 | 765 |
| Friends of Friends | 287,192 | 5,789 | 8,679 | 21,023 | 242,424 |
| Average Friend Rank | 9 | 2 | 3 | 6 | 8 |
| Average Friend IR | 91% | 65% | 56% | 90% | 23% |
| Average Friend Time/Page | 6.20 | 2.40 | 0.56 | 0.89 | 0.77 |
| Groups | 242 | 65 | 32 | 89 | 4 |
| Quality of Groups | 10 | 3 | 7 | 6 | 1 |
| Events | 9 | 1 | 3 | 2 | 1 |
| Quality of Events | 7 | 4 | 5 | 9 | 6 |
| Networks | 132 | 2 | 32 | 43 | 76 |
| People in Networks | 736,251 | 34,623 | 234,567 | 456,783 | 467,564 |
| Interests | 65 | 1 | 34 | 6 | 17 |
| Sports | 12 | 3 | 5 | 4 | 6 |
| Movies | 31 | 4 | 9 | 3 | 12 |

Profiles

| Monthly Data | 6 | 7 | 8 | 9 | 10 |
|---|---|---|---|---|---|
| Page Views | 219 | 12 | 414 | 789 | 1 |
| Unique Page Views | 89 | 1 | 210 | 290 | 1 |
| Interaction Rate (CTR) | 65% | 65% | 147% | 65% | 1% |
| Time/Page View | 5.87 | 6.87 | 7.87 | 8.87 | 1.00 |
| Ad CTR on Profile | 0.04% | 0.03% | 0.60% | 0.90% | 0.01% |
| Friends Added | 27 | 32 | 12 | 26 | 1 |
| Groups Added | 1 | 5 | 8 | 0 | 1 |
| Wall Posts Added | 4 | 6 | 5 | 5 | 1 |
| Networks Added | 3 | 2 | 3 | 3 | 0 |
| Photos Added | 3 | 34 | 3 | 2 | 1 |
| Photo Tages Added | 2 | 23 | 2 | 2 | 1 |
| Friends | 333 | 22 | 2 | 479 | 1 |
| Friends of Friends | 2,345 | 2,345 | 3,578 | 9,790 | 10 |
| Average Friend Rank | 2 | 4 | 8 | 5 | 1 |
| Average Friend IR | 26% | 87% | 67% | 67% | 10% |
| Average Friend Time/Page | 4.00 | 5.00 | 0.65 | 0.21 | 0.10 |
| Groups | 187 | 43 | 7 | 23 | 1 |
| Quality of Groups | 2 | 9 | 6 | 3 | 1 |
| Events | 3 | 6 | 1 | 2 | 0 |
| Quality of Events | 5 | 3 | 2 | 0 | 1 |
| Networks | 98 | 43 | 23 | 2 | 1 |
| People in Networks | 456,354 | 343,434 | 34,345 | 565,439 | 20 |
| Interests | 45 | 20 | 3 | 23 | 1 |
| Sports | 5 | 5 | 3 | 6 | 1 |
| Movies | 12 | 2 | 1 | 5 | 1 |

In Table 2, the attributes for each user profile are listed in the first column while attribute data for each of the profiles 1 through 10 is listed under each of the numbers “1” trough “10.”

Returning to FIG. 3, once filtering and targeting application 112 has obtained the attribute data from the user profiles in step 304, application 112 compares attribute data between user profiles and generates “scores” to be assigned to each attribute in each user profile in step 306. Each score is a measure of how active and influential each user profile is within the social network relevant to the other user profiles.

As an example of step 306, the attribute data provided for Profiles 1 through 10 in Table 2 is analyzed to produce scores for each attribute for each user profile, as provided in Table 3. As shown, a score of “1.00” is given for the highest value for each attribute, with lower scores being percentages of 1.00. The scoring of attribute values in Table 3 is provided using a PERCENTRANK function available in Microsoft® Office Excel Version 2003 (available by Microsoft Corp.). Step 306 of applying scores to the attribute data may be performed using other scoring or ranking algorithms known to one of ordinary skill in the art.

TABLE 3
Ranking of Profiles 1 through 10 based on Attribute Data

| | Profiles | | | | | | | | | |
|---|---|---|---|---|---|---|---|---|---|---|
| | 1 | 2 | 3 | 4 | 5 | 6 | 7 | 8 | 9 | 10 |
| Page Views | 1.00 | 0.78 | 0.22 | 0.22 | 0.56 | 0.44 | 0.11 | 0.67 | 0.89 | 0.00 |
| Unique Page Views | 1.00 | 0.67 | 0.22 | 0.33 | 0.56 | 0.44 | 0.00 | 0.78 | 0.89 | 0.00 |
| Interaction Rate (CTR) | 1.00 | 0.56 | 0.67 | 0.11 | 0.78 | 0.22 | 0.22 | 0.78 | 0.22 | 0.00 |
| Time/Page View | 1.00 | 0.33 | 0.11 | 0.22 | 0.44 | 0.56 | 0.67 | 0.78 | 0.89 | 0.00 |
| Ad CTR on Profile | 1.00 | 0.78 | 0.67 | 0.11 | 0.22 | 0.44 | 0.22 | 0.56 | 0.78 | 0.00 |
| Friends Added | 1.00 | 0.33 | 0.11 | 0.89 | 0.67 | 0.56 | 0.67 | 0.22 | 0.44 | 0.00 |
| Groups Added | 1.00 | 0.78 | 0.11 | 0.56 | 0.44 | 0.11 | 0.67 | 0.89 | 0.11 | 0.00 |
| Wall Posts Added | 1.00 | 0.78 | 0.22 | 0.22 | 0.78 | 0.11 | 0.67 | 0.22 | 0.22 | 0.00 |
| Networks Added | 1.00 | 0.89 | 0.22 | 0.67 | 0.78 | 0.22 | 0.11 | 0.22 | 0.22 | 0.00 |
| Photos Added | 1.00 | 0.22 | 0.22 | 0.89 | 0.67 | 0.22 | 0.67 | 0.22 | 0.11 | 0.00 |
| Photo Tages Added | 1.00 | 0.11 | 0.56 | 0.89 | 0.78 | 0.11 | 0.67 | 0.11 | 0.11 | 0.00 |
| Friends | 1.00 | 0.56 | 0.33 | 0.89 | 0.78 | 0.44 | 0.22 | 0.11 | 0.67 | 0.00 |
| Friends of Friends | 1.00 | 0.44 | 0.56 | 0.78 | 0.89 | 0.11 | 0.11 | 0.33 | 0.67 | 0.00 |
| Average Friend Rank | 1.00 | 0.11 | 0.33 | 0.67 | 0.78 | 0.11 | 0.44 | 0.78 | 0.56 | 0.00 |
| Average Friend IR | 1.00 | 0.44 | 0.33 | 0.89 | 0.11 | 0.22 | 0.78 | 0.56 | 0.56 | 0.00 |
| Average Friend Time/Page | 1.00 | 0.67 | 0.22 | 0.56 | 0.44 | 0.78 | 0.89 | 0.33 | 0.11 | 0.00 |
| Groups | 1.00 | 0.67 | 0.44 | 0.78 | 0.11 | 0.89 | 0.56 | 0.22 | 0.33 | 0.00 |
| Quality of Groups | 1.00 | 0.33 | 0.78 | 0.56 | 0.00 | 0.22 | 0.89 | 0.56 | 0.33 | 0.00 |
| Events | 1.00 | 0.11 | 0.67 | 0.44 | 0.11 | 0.67 | 0.89 | 0.11 | 0.44 | 0.00 |
| Quality of Events | 1.00 | 0.44 | 0.56 | 0.89 | 0.78 | 0.56 | 0.33 | 0.22 | 0.11 | 0.00 |
| Networks | 1.00 | 0.11 | 0.44 | 0.56 | 0.78 | 0.89 | 0.56 | 0.33 | 0.11 | 0.00 |
| People in Networks | 1.00 | 0.22 | 0.33 | 0.67 | 0.78 | 0.56 | 0.44 | 0.11 | 0.89 | 0.00 |
| Interests | 1.00 | 0.00 | 0.78 | 0.33 | 0.44 | 0.89 | 0.56 | 0.22 | 0.67 | 0.00 |
| Sports | 1.00 | 0.11 | 0.44 | 0.33 | 0.78 | 0.44 | 0.44 | 0.11 | 0.78 | 0.00 |
| Movies | 1.00 | 0.44 | 0.67 | 0.33 | 0.78 | 0.78 | 0.22 | 0.00 | 0.56 | 0.00 |

For example, in Table 3, Profile 1 had the highest value for the attribute Page Views within the last month, compared to Profiles 2 through 10. Thus, the attribute Page Views for Profile 1 is assigned a score of 1.00. Accordingly, the amount of Page Views recorded for Profile 3 within the last month as compared to the Page Views recorded for Profiles 1, 2, and 4 through 10 is assigned a score of 0.22 using the PERCENTRANK function.

Returning to FIG. 3, once the attributes have been assigned a score for each user profile in step 306, process 300 proceeds to step 308 where filtering and targeting application 112 assigns a weight to each attribute to reflect the importance of that attribute to the marketer in determining the social rank of the user profiles. For example, using the attributes provided in Tables 2 and 3, a marketer may wish to target users having a high click-thru rate (“Interaction Rate (CTR)” from Table 3) for advertisements displayed on each user profile webpage, and users having a large amount of time spent by friends of each user profile viewing the profile webpage (“Average Friend Time/Page” from Table 3). The same marketer, however, is not concerned with how many friends a user has added to the user profile's webpage within the last month (“Friends Added” in Table 3) or how many sports a user has listed on the user profile webpage within the last month (“Sports” in Table 3). Accordingly, filtering and targeting application 112 assigns a higher weight value to each of the Interaction Rate (CTR) and Average Friend Time/Page attributes and assigns a lower weight value to each of the Friends Added and Sports Attributes from Table 3, in step 308.

Filtering and targeting application 112 multiples the scores previously determined for each attribute in step 306 by the attribute weights assigned in step 308 to produce weighted scores for each attribute of each user profile, in step 310. In step 312, filtering and targeting application 112 sums up the weighted scores for each user profile to produce a profile score. Table 4 provides an example of profile scores for each of User Profiles 1 through 10 from Tables 2 and 3.

TABLE 4
Weighted Profile Scores for Profiles 1 through 10

| | | Profiles | | | | | | | | | |
|---|---|---|---|---|---|---|---|---|---|---|---|
| | Weight | 1 | 2 | 3 | 4 | 5 | 6 | 7 | 8 | 9 | 10 |
| Page Views | 8 | 8.00 | 6.22 | 1.78 | 1.78 | 4.44 | 3.55 | 0.89 | 5.33 | 7.10 | 0.00 |
| Unique Page Views | 9 | 9.00 | 5.99 | 2.00 | 3.00 | 5.00 | 4.00 | 0.00 | 6.99 | 7.99 | 0.00 |
| Interaction Rate (CTR) | 10 | 10.00 | 5.55 | 6.66 | 1.11 | 7.77 | 2.22 | 2.22 | 7.77 | 2.22 | 0.00 |
| Time/Page View | 7 | 7.00 | 2.33 | 0.78 | 1.55 | 3.11 | 3.89 | 4.66 | 5.44 | 6.22 | 0.00 |
| Ad CTR on Profile | 9 | 9.00 | 6.99 | 5.99 | 1.00 | 2.00 | 4.00 | 2.00 | 5.00 | 6.99 | 0.00 |
| Friends Added | 2 | 2.00 | 0.67 | 0.22 | 1.78 | 1.33 | 1.11 | 1.33 | 0.44 | 0.89 | 0.00 |
| Groups Added | 3 | 3.00 | 2.33 | 0.33 | 1.67 | 1.33 | 0.33 | 2.00 | 2.66 | 0.33 | 0.00 |
| Wall Posts Added | 4 | 4.00 | 3.11 | 0.89 | 0.89 | 3.11 | 0.44 | 2.66 | 0.89 | 0.89 | 0.00 |
| Networks Added | 5 | 5.00 | 4.44 | 1.11 | 3.33 | 3.89 | 1.11 | 0.56 | 1.11 | 1.11 | 0.00 |
| Photos Added | 2 | 2.00 | 0.44 | 0.44 | 1.78 | 1.33 | 0.44 | 1.33 | 0.44 | 0.22 | 0.00 |
| Photo Tages Added | 6 | 6.00 | 0.67 | 3.33 | 5.33 | 4.66 | 0.67 | 4.00 | 0.67 | 0.67 | 0.00 |
| Friends | 9 | 9.00 | 5.00 | 3.00 | 7.99 | 6.99 | 4.00 | 2.00 | 1.00 | 5.99 | 0.00 |
| Friends of Friends | 2 | 2.00 | 0.89 | 1.11 | 1.55 | 1.78 | 0.22 | 0.22 | 0.67 | 1.33 | 0.00 |
| Average Friend Rank | 8 | 8.00 | 0.89 | 2.66 | 5.33 | 6.22 | 0.89 | 3.55 | 6.22 | 4.44 | 0.00 |
| Average Friend IR | 6 | 6.00 | 2.66 | 2.00 | 5.33 | 0.67 | 1.33 | 4.66 | 3.33 | 3.33 | 0.00 |
| Average Friend Time/Page | 10 | 10.00 | 6.66 | 2.22 | 5.55 | 4.44 | 7.77 | 8.88 | 3.33 | 1.11 | 0.00 |
| Groups | 8 | 8.00 | 5.33 | 3.55 | 6.22 | 0.89 | 7.10 | 4.44 | 1.78 | 2.66 | 0.00 |
| Quality of Groups | 6 | 6.00 | 2.00 | 4.66 | 3.33 | 0.00 | 1.33 | 5.33 | 3.33 | 2.00 | 0.00 |
| Events | 5 | 5.00 | 0.56 | 3.33 | 2.22 | 0.56 | 3.33 | 4.44 | 0.56 | 2.22 | 0.00 |
| Quality of Events | 6 | 6.00 | 2.66 | 3.33 | 5.33 | 4.66 | 3.33 | 2.00 | 1.33 | 0.67 | 0.00 |
| Networks | 5 | 5.00 | 0.56 | 2.22 | 2.78 | 3.89 | 4.44 | 2.78 | 1.67 | 0.56 | 0.00 |
| People in Networks | 6 | 6.00 | 1.33 | 2.00 | 4.00 | 4.66 | 3.33 | 2.66 | 0.67 | 5.33 | 0.00 |
| Interests | 3 | 3.00 | 0.00 | 2.33 | 1.00 | 1.33 | 2.66 | 1.67 | 0.67 | 2.00 | 0.00 |
| Sports | 2 | 2.00 | 0.22 | 0.89 | 0.67 | 1.55 | 0.89 | 0.89 | 0.22 | 1.55 | 0.00 |
| Movies | 2 | 2.00 | 0.89 | 1.33 | 0.67 | 1.55 | 1.55 | 0.44 | 0.00 | 1.11 | 0.00 |
| | Score | 143.00 | 68.38 | 58.16 | 75.15 | 77.15 | 63.94 | 65.60 | 61.49 | 68.93 | 0.00 |

In Table 4, the weights assigned to each attribute are listed in the “Weight” column and reflect the desired impact that each attribute should have on the ranking of the user profiles. The profile score for each of Profiles 1 through 10 is provided in the “Score” rows at the bottom of Table 4.

Once the user profiles have each been assigned a profile score in step 312, filtering and targeting application 112 divides the scored user profiles into subsets to rank the scored user profiles against one another within the social network. This produces the “social rank” for each user profile, wherein the social rank, as defined above, is the value of each user profile relevant to the other user profiles within the closed system of the online social network. Two different methods of grouping the scored user profiles will be described; however the scope of the invention is not limited to these two methods.

Continuing in FIG. 3, the marketer decides how the social rank of the scored user profiles should be determined at step 314. A first option, step 316, provides for filtering and targeting application 112 to group the scored user profiles in numerical order of each user profile's score, then divide the group into equal intervals. An example of step 316 is shown in Table 5 and Graph 1 below.

TABLE 5
Ranking of User Profile Scores from Table 4

| | Profiles | | | | | | | | | |
|---|---|---|---|---|---|---|---|---|---|---|
| | 1 | 2 | 3 | 4 | 5 | 6 | 7 | 8 | 9 | 10 |
| Score | 143.00 | 68.38 | 58.16 | 75.15 | 77.15 | 63.94 | 65.60 | 61.49 | 68.93 | 0.00 |
| Rank | 10 | 6 | 2 | 8 | 9 | 4 | 5 | 3 | 7 | 1 |

In Table 5, the user profile scores of Table 4 are ranked from 1 to 10, with a “1” representing the lowest profile score and a “10” representing the highest profile score. This ranking method is applied to all of the user profiles analyzed by filtering and targeting application 112 in step 316a. Application 112 equally divides ranked user profiles into a pre-specified number of intervals in step 316a.

FIG. 25 shows graph 2500 where a total of 2,479,885 scored user profiles have been grouped by social rank order and divided into ten intervals filtering and targeting application 112 using process 300, with a total of 247,989 user profiles in each interval. In FIG. 25, scored user profiles are plotted using the associated social rank, shown at 2502, with the desirability, shown at 2504, of each user profile increasing along the left y-axis from a low social rank to a high social rank. Each circle, shown at 2506, represents an individual user profile and each boxed numeral, shown at 2508, represents a group profile rank along the right y-axis of graph 2500. Since the total of user profiles is divided into equal numbers, user profiles with different social rank values may fall into a single group profile rank. For example, Group Profile Rank Ten, shown at 2510 may contain user profiles with a social rank of 10, 9 and 8.

Once grouped by together in step 316a, the ranked user profiles are ready to be filtered by filtering and targeting application 112 as previously described with respect to FIG. 2. In step 318, the ranked user profiles can be delivered to an ad management application, such as ad management application 114 (see FIG. 1), for further processing, where the social rank values of the user profiles are integrated into creating a targeted advertisement campaign by the marketer. In an alternate embodiment, the ranked user profiles are further processed by filtering and targeting application 112 using the filters shown in FIG. 2.

A determination at step 320 is made to either terminate process 300 at step 322 or repeat process 300 at step 324 to determine the social rank for another group of user profiles, for example or a group of user profiles from multiple social networks.

Another method of grouping the scored user profiles produced in step 312 is for filtering and targeting application 112 to cluster user profiles with the same individual profile rank, at step 316b. For example, each user profile with a profile score greater than or equal to 100.00 is assigned a social rank of 10, while each user profile with a profile score less than 100 but greater than or equal to 82.5 is assigned a social rank of 9, and so on. Filtering and targeting application 112 then clusters the ranked user profiles into groupings of identical social rank value, that is, all the user profiles with a social rank of 10 are grouped together, all the user profiles with a social rank of 9 are grouped together, and so on.

FIG. 26 shows a graphical illustration of clustering the scored social profiles shown in graph 2500 (see FIG. 25) based on the individual social rank. In graph 2600, a total of 2,479,885 scored user profiles divided into groups for each social rank value. Thus, the number of user profiles with a social rank of 6, shown at 2610, may not equal the number of user profiles with a social rank of 8, shown at 2612. Similar to graph 2500 (see FIG. 2500), individual user profiles are represented by a circle, shown at 2606, and each boxed number, shown at 2608, represents the social rank value. The desirability 2604 of user profiles to the marketer increases from a social rank of 1 to a social rank of 10 along the right y-axis of graph 2600, as shown at 2602.

Again, once the user profiles have been clustered by social rank, filtering and targeting application 112 proceeds to deliver the ranked user profiles for further processing at step 318. At step 320, process 300 may end at step 322 or may repeat at step 324.

Although social rank process 300 depicted in FIG. 3 has been described as performed by the filtering and targeting application 112 (see FIG. 1), a social rank of each user profile can be determined through using a different application outside of the filtering and targeting application.

As discussed previously in FIG. 2, a psychographic filter, such as psychographic filter 216, can be applied to the user profiles to select users with specific lifestyles, personalities, interests and values that are of interest to the marketer. User profiles in a social network must be initially categorized to determine the level of interest of each user profile using the attribute data gathered from each user profile in order to apply a psychographic filter. A process for generating psychographic categories and assigning user profiles to the psychographic categories is depicted in FIG. 4.

As shown in FIG. 4, a filtering and targeting application, such as filtering and targeting application 112 (see FIG. 1), begins process 400 at step 402 and proceeds to step 404 where a list of psychographic categories is generated to apply to the user profiles. The list may include any number of psychographic categories, including, but not limited to, movies, sports, lifestyle, work habits, and the like. Examples of psychographic categories are presented below:

Categories: Movie Types

### Category 1.: Movies—Action & Adventure—Action-Comedy

### Category 2.: Movies—Action & Adventure—Action-Thriller

### Category 3.: Movies—Action & Adventure—Adventure-Drama

### Category 4.: Movies—Action & Adventure—Comic Book & SuperHero

### Category 5.: Movies—Action & Adventure—Dragon-Dynasty

### Category 6.: Movies—Action & Adventure—Epic

### Category 7.: Movies—Action & Adventure—Martial Arts/Samurai

Filtering and targeting application 112 also generates a list of keywords associated with each psychographic category. For example, keywords associated with Category 7 may include, but are not limited to, martial arts, Japanese, Bruce Lee, dragon, fighting, sword-fighting, and the like. The listed keywords will be used to crawl through the Internet to identify webpages containing one or more of the listed keywords.

Once the lists of categories and associated keywords are generated, a list of Internet addresses, herein referred to as Uniform Resource Locators or “URLs”, is generated, in step 406. Using the movie category example, a URL list may comprise a listing of web addresses for webpages containing one or more specific movie titles that fall within each of the movie categories. The URL list generated in step 406 is a starting list of webpages to begin crawling for the listed keywords generated in step 404 in order to categorize the URLS.

In step 408, a list of stopwords also is generated to be combined with the lists of categories, keywords and URLs. A stopword is defined as a term that occurs frequently in conversational and written language and should be excluded from the crawling process of the URLs, such as, for example, the terms “the,” “and,” “him,” “her,” and the like. The removal of stopwords increases the speed and efficiency of crawling a webpage for keywords, since the stopwords are ignored.

In step 410, a web crawling application, such as, for example, WebCrawler® (WEBCRAWLER is a registered trademark to Infospace, Inc.), receives each of the category, keyword, URL and stopword lists and begins to crawl webpages on the Internet using the URL list as a starting point. When a keyword is identified on a webpage, the web crawling application records the URL, which keywords were found, and the frequency of each keyword on that URL. The crawling application also follows links to other webpages listed on the listed URL pages for keyword searching. The web crawling application stops once a maximum number of webpages is reached, or once the frequency of keywords falls below a predetermined rate.

Once the web crawling application is complete in step 410, the web crawling application generates a keyword/webpage matrix in step 412. The keyword/webpage matrix lists the data found by the web crawling application, including what URLs were searched, the keywords found on each URL, and the frequency of the keywords found on each URL.

Process 400 proceeds to step 414 where a clustering algorithm is applied to the keyword/webpage matrix to compute keyword clusters from the webpages crawled. In this application, a keyword cluster represents a group of webpages that are statistically similar in the keywords they contain. Clustering algorithms that may be used include, but are not limited to, Singular Value Decomposition (SVD), Principal components Analysis (PCA), FastPCA, KMeans, Correlation computation, and the like.

An example of a keyword cluster is provided in Cluster A, which contains a listing of 100 URLs:

### Cluster A

1. http://www.imdb.com/title/tt0328107/—Man on Fire, Movie, Preview, Thriller, Action, Bars, Tony Scott, Revenge, Compassion, Disturbing, Tense, Mercenary
2 . . . .
3 . . . . . . . .
100. http://www.imdb.com/title/tt0112864/—Die Hard With a Vengeance, John McTiernan, Roderick Thorp, Action, Crime, Thriller, John McClane, Bomber, Game, Death, Car, Opening Credits

In Cluster A, the web crawling application crawled through multiple websites covering different movies produced, collected a total of 100 movie webpages that are statistically similar to each other using the keywords searched for, and grouped the 100 webpages together as Cluster A.

Once the keyword clusters are generated, the clusters are assigned to one or more of the associated psychographic categories in step 416. A keyword cluster can be assigned to more than one category. Using the Movie Types example above, Cluster A may be placed in both Category 2: Movies—Action & Adventure—Action-Thriller and Category 3: Movies—Action & Adventure—Adventure-Drama.

The user profiles are now categorized using the keywords clusters computed in step 414 and categorized in step 416 in FIG. 4. In step 418, the web crawling application is applied to the user profiles from the social network using the keyword clusters. User profiles with a specified percentage of one or more keywords then are assigned to a related psychographic category based on the keywords found on each profile, in step 420.

For example, user profiles that contain the movie titles “Man On Fire” and/or “Die Hard with a Vengeance” on the profile webpages would be assigned to Categories 2 and 3 from the Category Movie Types list. Users that do not list either of these titles on the profile webpages but discuss an interest in action-thriller movies and adventure-drama movies on the profile webpages also would be assigned to Categories 2 and 3 in the above example. Thus, when filtering through multiple user profiles, a marketer who wishes to advertise videos of action movies can specify that only user profiles that fall under the psychographic category of Category 2 for action-thriller movies should be targeted.

Returning to FIG. 4, once user profiles are assigned categories in step 420, process 400 proceeds to step 422 where process 400 may be terminated at step 424 or may be repeated at step 426 if desired. Thus, the utilization of attribute data from a user profile is not limited to what may be listed under the title “Interests” on a user profile webpage, but illustratively includes analyzing all possible keywords on the profile webpage, including discussions posted on the profile webpage, links to other websites posted on the profile webpage, and keywords listed in other areas of the user profile webpage, to identify the personality and personal interests of the user profile for determination of an ad campaign of peak interest to the user profile owner.

Although process 400 is described as performed by filtering and targeting application 112 (see FIG. 1), other embodiments of the present invention include a system that generates a psychographic filter using different applications.

FIGS. 3 and 4 depict processes for determining the social rank value for a user profile and for determining the psychographic categorization of a user profile, respectively, for use in filtering through a plurality of user profiles within a social network using a filtering and targeting application, such as filtering and targeting application 112 depicted in FIGS. 1 and 2. Once a final selection of user profiles is derived, this final selection is ready to be combined with one or more targeted advertisement campaigns.

To deliver a targeted ad campaign to the final selection of user profiles, such as selected user profiles 230 filtered using filtering and targeting application 112 (see FIG. 2), the selected user profiles are transmitted to an advertisement management system, such as advertisement management application 114 (see FIG. 1). Additionally, the marketer intending to serve a targeted ad campaign to the selected user profiles submits advertisement creatives to the ad management application 114, which includes, but is not limited to, the display and pictorial elements of the advertisement content, such as the text, graphical images, and the like.

The marketer also submits ad campaign rules to ad management application 114, including, for example, a total number of times each ad in the ad campaign should be displayed, herein referred to as “ad frequency,” what visual resolution the advertisements should be displayed at, an order of display of the ads in the ad campaign, a length of time each ad should run if the ads are to rotate, what type of user profiles the ad campaign should be served to, whether the ad campaign should be shown to visitors of the selected user profiles 230 based on the user profile of each visitor, whether some or all of the ads should be shown during a certain time of day, and whether the ad campaign should be served to user profiles in a selected location (if selected user profile 230 has not been previously filtered by geographic location).

Once ad management application 114 receives the ad creatives and ad campaign rules from the marketer, ad management application 114 determines when each ad should be delivered to each selected user profile 230 using ad selection and delivery logic previously specified by the marketer. Once ad management application 114 determines the proper logic for selecting and delivering each advertisement in the ad campaign, the ads then are transmitted to the proper advertisement delivery system for delivery to each user profile, such as advertisement delivery system 116 previously described with respect to FIG. 1. An ad delivery system 116 illustratively includes display and text delivery systems, such as, billboards, kiosk, mobile devices, in-game online networks, and holograms.

The ad selection and delivery logic applied by ad management system 114 is previously specified by the marketer of the ad campaign. Although two methods of selection and delivery logic will be described, the present invention is not so limited.

To deliver ads to the selected user profiles, a marketer may buy advertisement rights to a user profile owner within a social network, that is, the ads within an advertisement campaign would be delivered to a single person online at a time, according to an embodiment of the present invention. Thus, a first method of logic for selecting and delivering advertisements includes selecting an advertisement specific to the user profile owner based on the attribute data gathered from the associated user profile. The selected ad is delivered whenever the profile owner logs into his or her user profile webpage in the social network.

Other user profiles visiting the selected user profile owner would also view the selected advertisements, allowing the selected ads to potentially reach a larger audience than just the user profile owner. If the user profile owner happens to be popular within the social network and receives a large amount of visitors or is influential over other users, the marketer may receive a positive result from displaying the ads on the particular profile owner's webpage.

Another aspect of this embodiment includes ad management system 114 delivering the selected ads to the user profile owner as he or she navigates to other Internet webpages outside of the social network. Thus, the targeted ad campaign can be delivered to the user profile owner as the owner visits other websites such as, for example, a news website, a retail website, and a sports website

A second method of ad selection and delivery logic includes selecting and delivering ads to a specific user profile in a social network based on the social rank of the user profile. A marketer may wish to buy advertisement rights to a specific user profile using the social rank value previously generated for the user profile. Thus, if a user profile webpage is open, meaning either the profile owner is logged in or other user profiles are viewing the user profile webpage, the ad management system would select and deliver an advertisement based on the highest social ranked profile that is active on the specific webpage. The highest social rank may belong to either the user profile owner or a visitor of the profile webpage based on the visitor's profile. For example, a user profile owner logs into his or her profile webpage and contemporaneously has five other user profiles visiting his or her profile webpage. If the user profile owner has the highest social rank among the other user profiles, the ad management system will select an advertisement suited for the user profile owner. However, if one of the five user profiles visiting the owner's profile webpage has a higher social rank than the profile owner, the ad management system will select an advertisement targeted to the user profile visitor. In using this logic, the ad management system delivers the most relevant ad to the available audience.

Here, Internet ads also can be selected and delivered to individual users as they navigate to other Internet webpages outside of the social network. For example, if three users from the social network navigate to the same search engine webpage, the ad management system will select an advertisement based on an associated user profile that has the highest social rank of the three users.

The above description is applicable to one marketer with one or more advertising campaigns. However, when multiple marketers wish to buy advertising rights to the same user profile owner or user profiles and compete against each other, the marketers must bid against each other for such advertisement rights. Through the present invention, a buying platform can be provided, via an advertisement marketplace that commoditizes user profiles within one or more social networks, through which marketers can view available user profiles and the associated attributes from a social network, select desired user profiles, and bid for advertising rights regarding the desired user profiles against other marketers.

Here, marketers can browse through a group of user profiles from one or more social networks and select ideal user profiles that the marketers wish to bid on for advertisement rights. The marketer with the highest bid price for a user profile will have the marketer's ads displayed on that user profile webpage. Ad campaigns of marketers with lower bids that the top bidding marketer will not be displayed until the top bidding ad campaign either expires or reaches a maximum impression value. The marketplace allows for marketers to manage bidding and purchasing of ad rights, including increasing or decreasing bids for a user profile, to change the marketer's advertising spending as needed. An aspect of this embodiment includes marketers selecting filters to be applied to a plurality of user profiles in order to produce a selected set of user profiles for an advertisement campaign. Another aspect of this embodiment includes marketers building an ad campaign using the marketplace, and integrating that ad campaign with the selected set of user profiles.

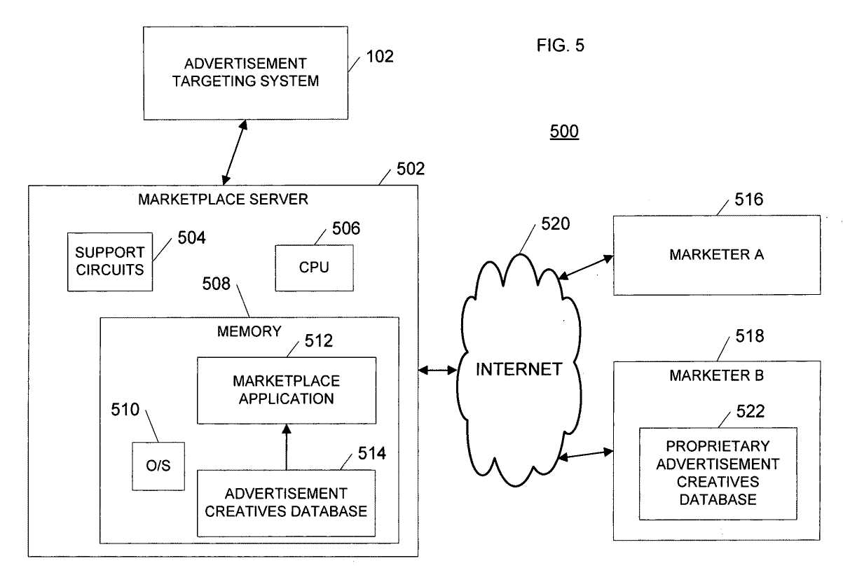

FIG. 5 shows a system for providing a marketplace to advertising marketers. In FIG. 5, system 500 includes marketplace server 502 containing computer processing unit (CPU) 504, support circuits 506 (similar to support circuits 104 well-known and shown in FIG. 1) and memory 508 (similar to memory 108 shown in FIG. 1). Memory 508 stores various software packages and components, such as operating system (O/S) 510 and software applications, including marketplace application 512 and advertisement creatives database 514.

Marketplace server 502 interacts with an advertisement targeting system, such as ad targeting system 102 shown in FIG. 1. Marketplace application 512 obtains user profile information, including attribute data, from ad targeting system 102. Marketers, such as marketer A 516 and marketer B 518, utilize marketplace application 512 through Internet 520. Marketer A may use marketplace application 512 to apply one or more filters to a group of user profiles to generate a selected group for delivering a targeted advertisement campaign. Marketplace application 512 can transmit the selected filters to ad targeting system 102, where user profiles from one or more social network are filtered using a filtering and targeting system, such as filtering and targeting application 112 depicted in FIGS. 1 and 2. The selected group of user profiles is then made available to Marketer A 516 using marketplace application 512 where Marketer A 516 can bid for advertisement space on each selected user profile webpage in the social network, and/or on other websites visited by each selected user profile. Marketer B 518 also may wish to bid on access to the same selected user profiles using marketplace application 512. Marketers A 516 and B 518 then can manage and modify their respective bids on the selected user profiles using marketplace application 512 as needed.

Marketers A 516 and 518 also can use marketplace application 512 to generate an advertisement campaign using advertisement creatives database 514 stored within memory 508. Alternately, Marketer B may use marketing application 512 to generate an ad campaign using proprietary ad creatives stored in repository 522 stored with Marketer B 518, or stored in a separate location (not shown). The ad campaign generated by marketplace application 512 would be combined with campaign rules stored in ad targeting system 102, and delivered to the selected group of user profile owners by ad targeting system 102. System 500 allows for marketers, such as Marketers A 516 and B 518, to efficiently manage ad campaigns and money spent on the campaigns as needed.

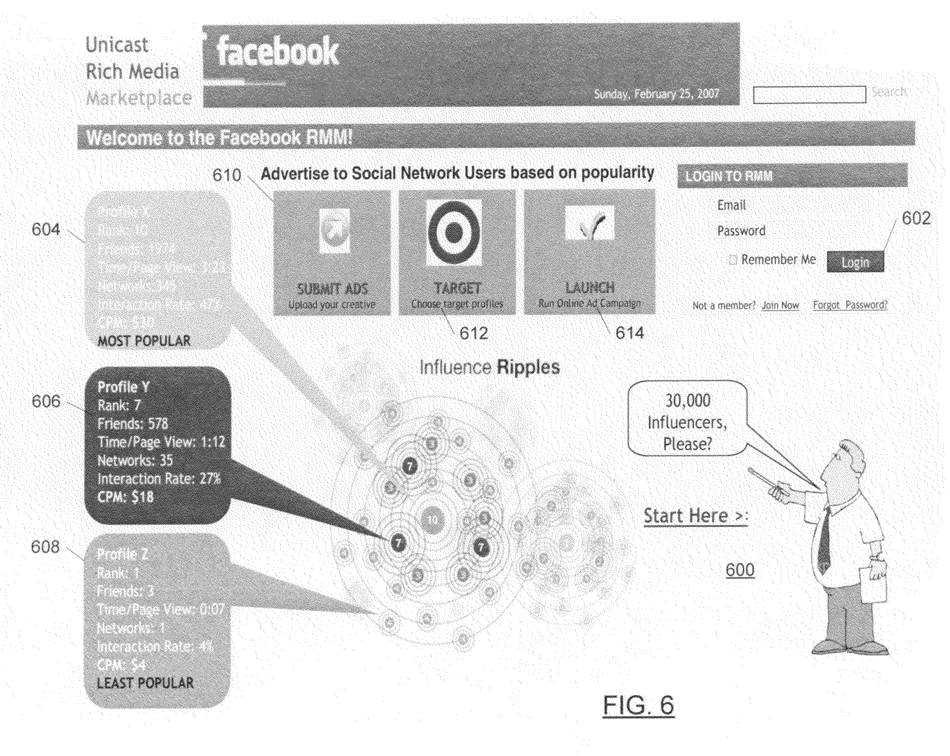

FIGS. 6-20 show graphical user interfaces, referred to herein as screenshots, associated with an advertisement marketplace application, such as marketplace application 512 shown in FIG. 5, for use with a FACEBOOK social network (provided by Facebook, Inc.), according to an embodiment of the present invention. Although FIGS. 6-20 are geared to the FACEBOOK social network, the invention encompasses advertising marketplace systems for any online social network.

FIG. 6 depicts a startup screenshot of a marketplace application for purchasing advertising rights to user profiles in the FACEBOOK social network. Screenshot 600 includes login prompt 602 where a marketer enters a username and password to log into the marketer's account, and examples of user profiles available to that marketer, such as Profile X 604, Profile Y 606, and Profile Z 608. Attribute data is shown for each user profile, including the current cost to purchase access for serving advertisements to the user profiles, which is the cost per one thousand page impressions or “CPM” value. A page impression is herein defined as an online user requesting to load a single webpage of an Internet website. For example, a user viewing an advertisement on a user profile webpage who clicks on an advertisement link to go to the ad website creates a recorded impression. CPMs are used to determine the value of a user profile based on the popularity and/or influence of the user profile compared to other user profiles in a social network where marketers pay a higher CPM for a more popular or influential user profile in the hope of reaching a larger advertising audience. As shown on screenshot 600, popular user profiles have a higher CPM value, such as Profile X 604 having a CPM of $30, compared to a less popular user profile, such as Profile Z 608 with a CPM value of $4.

From screenshot 600, the marketer selects what activity the marketer intends to perform. If the marketer wishes to generate an ad campaign, the marketer would click on Submit Ads icon 610. If the marketer wishes to select user profiles for an ad campaign, the marketer would click on Target icon 612. If the marketer wishes to run an ad campaign to deliver ads to one or more user profile owners, the marketer would click on Launch icon 614.

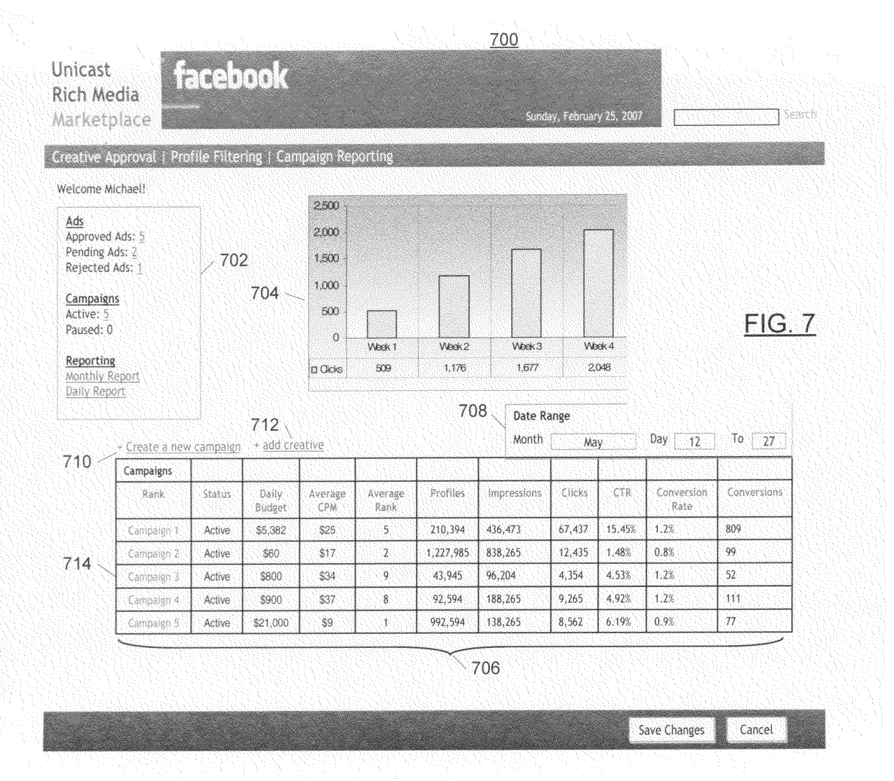

Once the marketer logs in, marketplace application presents screenshot 700, as shown in FIG. 7, providing a summary of the marketer's current advertisement campaigns and performance of such ad campaigns. Screenshot 700 includes information covering the current advertisements being delivered online and how many ad campaigns are currently active or inactive (paused) at section 702. A graphical summary of the performance of the marketer's ad campaigns is shown at 704, with the number of clicks representing the number of page impressions recorded for the ad campaigns. Data related to each of the marketer's ad campaigns is provided in section 706 for specified date range 708. From screenshot 700, a marketer may choose to create a new ad campaign by clicking on the “+Create a new campaign” link 710, may choose to upload an advertisement creative to the ad creatives database, such as database 514 (see FIG. 5) by clicking on “+add creative” link 712, or may view data associated with each ad campaign by clicking on a campaign name, such as, Campaign 2 714.

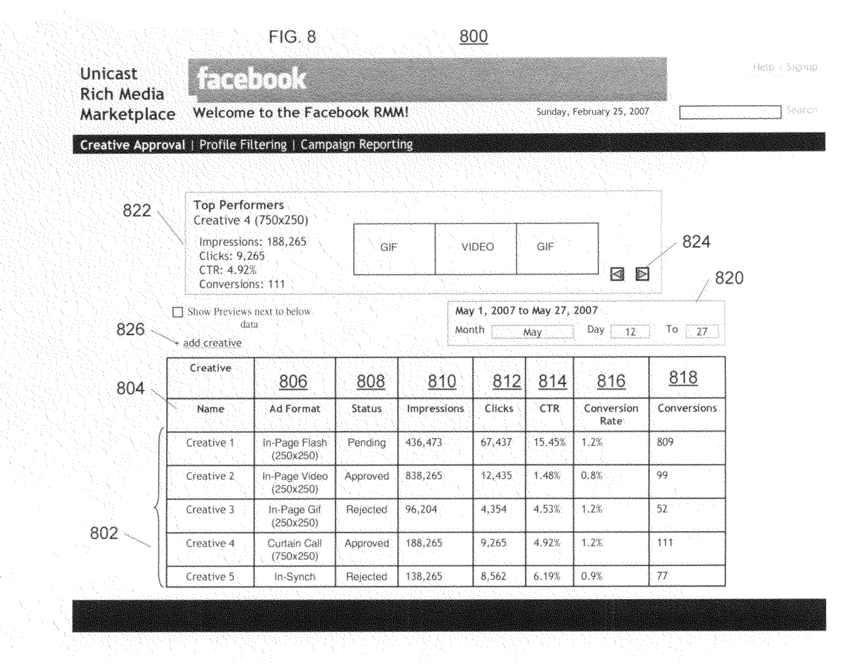

FIG. 8 depicts screenshot 800 providing analytics data for each ad creative 802 currently uploaded for the logged in marketer. On screenshot 800, for selected date range 820, the marketer may view name 804 of each ad creative, viewing format 806 of each ad creative, status 808 of each ad creative, for example, whether the ad creative is approved for use, has been rejected, or is pending approval for use, number of impressions 810 that recorded for each ad creative when an associated ad campaign is active, number of clicks 812 each ad creative has received when the associated ad campaign is active, click-thru-rate (CTR) 814 for each ad creative, conversion rate 816 for each ad creative, where the conversion rate defines how many users have made a purchase through the advertisement related to the ad creative compared to the CTR value, and total number of conversions 818 recorded for each ad creative.

On screenshot 800, the marketer can view the actual graphics and images underlying each ad creative at viewing section 822. The marketer can scroll through the images and analytics data for each ad creative using arrow keys 824. To either upload or generate a new ad creative using marketplace application 512, the marketer clicks on “+add creative” link 826.

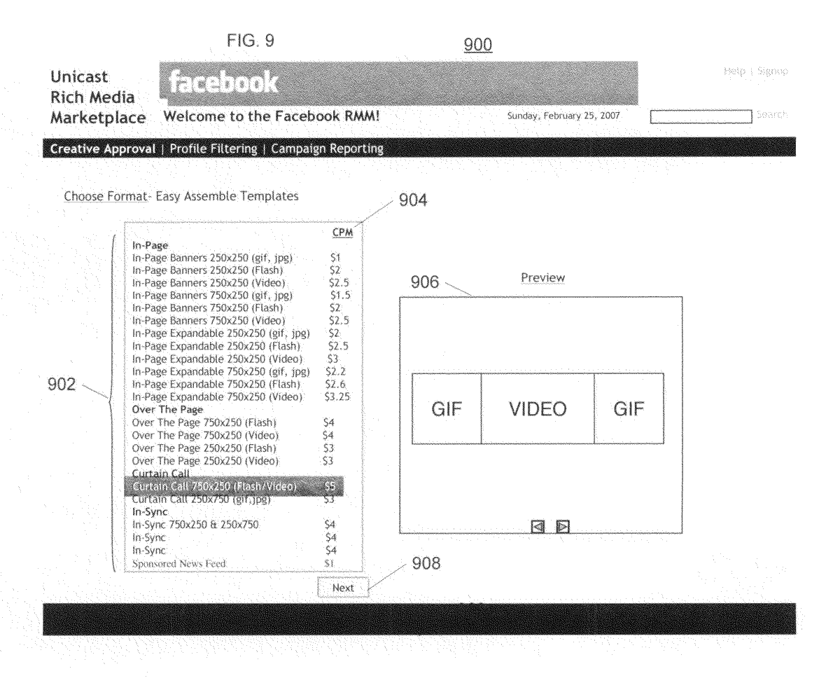

Clicking on “add creative” link 826 generates screenshot 900 in FIG. 9. In screenshot 900, the marketer chooses an ad format for a new ad creative from list 902 of ad format templates, where each ad format is associated with a base CPM value 904. Base CPM value 904 is part of the total market bidding CPM for an advertisement campaign and covers the costs associated with creating the ad campaign. The marketer can view an example of each ad format 902 in viewing section 906. For example, the marketer wishes to build an ad creative using the “curtain call” format template. The marketer selects curtain call format 906 and clicks on “Next” button 908.

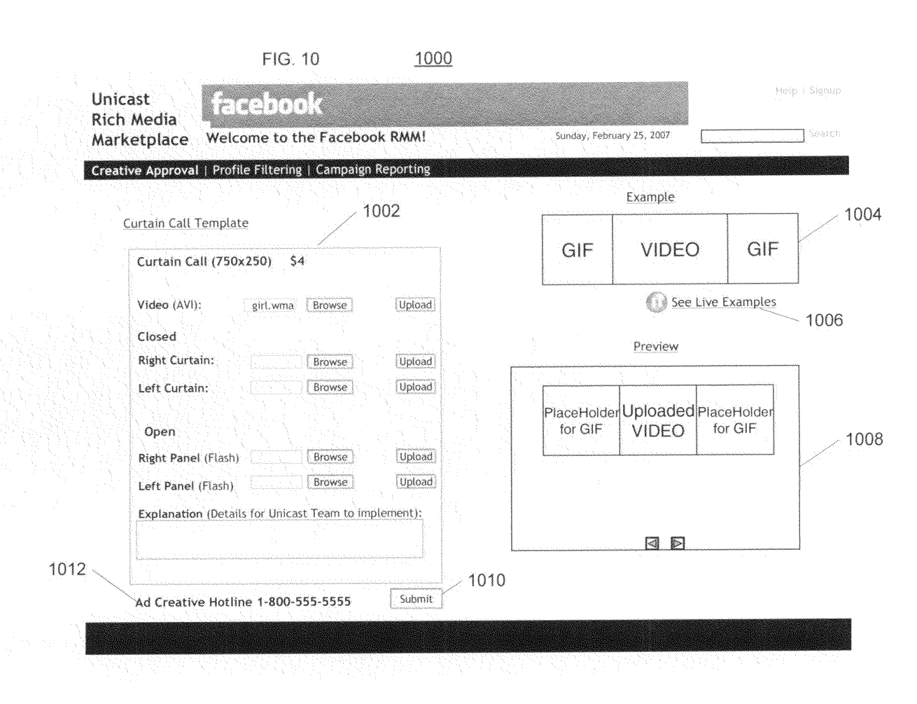

Once the marketer selects ad format 902, the marketplace application proceeds to screenshot 1000 in FIG. 10. Screenshot 1000 provides a template 1002 with a list of components for assembling the ad creative. As the marketer browses through the listed components, examples of the components can be viewed at viewing section 1004, with examples of currently active advertisements available to the marketer be clicking on “See Live Examples” link 1006. As the marketer uploads the creative components, the marketer can view the assembly of the actual ad creative at viewing section 1008. Once the marketer has assembled the ad creative, the marketer submits the creative for approval by clicking “Submit” button 1010. Approval of the ad creative may be performed internally by the marketing company or externally by the intended publisher of the ad, for example, the FACEBOOK social network, or an outside third party. For assistance with assembling the ad creative, the marketer may call an ad creative hotline displayed at 1012.

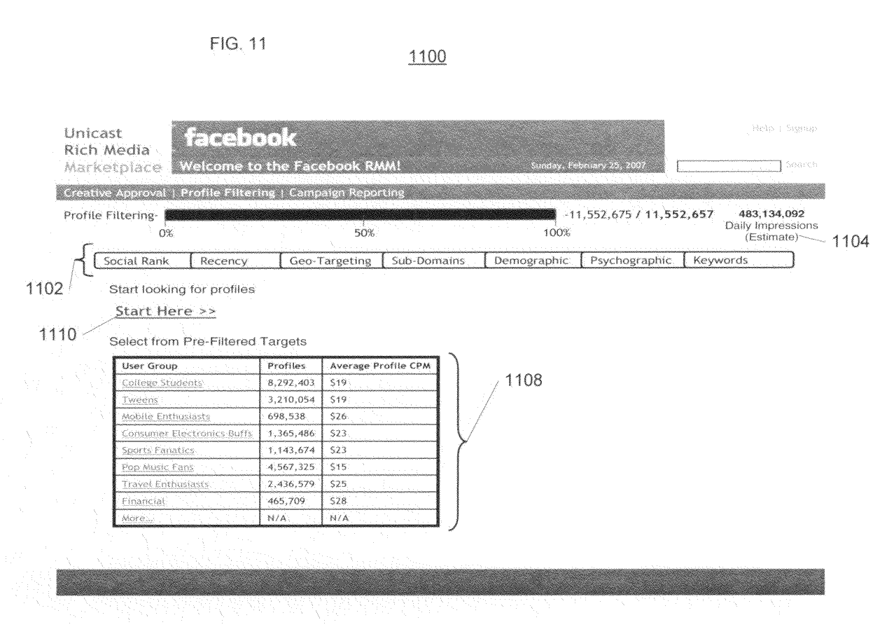

The marketer also can select desired user profiles from the FACEBOOK social network using a profile filtering component of marketplace application 512. FIG. 11 shows a screenshot 1100 presented to the marketer for beginning the process of filtering through user profiles in the FACEBOOK social network. On screenshot 1100, the marketer can view a number of user profiles currently available out of the total number of FACEBOOK user profiles at Profile Filtering status bar 1102. Since the marketer is at the beginning stage of the filtering process, all user profiles within the FACEBOOK social network are currently available to the marketer, as shown by counter “11,552,675/11,552,675” 1112. Here, counter 1112 shows the marketer that, prior to applying any filters, all 11,552,675 user profiles out of a total of 11,552,675 user profiles are available for bidding by the marketer. An estimated number of daily impressions for each user profile webpage that the marketer may expect from the available pool of user profiles over a given time period, for example, one month's time, is shown at display 1104. Display 1106 lists the filter types available to the marketer that can be applied to the user profiles. To start, the marketer can select user profiles to target from list 1108 of prefiltered groups of user profiles previously generated, either by the marketer or by the marketplace application 512. Alternatively, the marketer can choose to create a new selection of filtered user profiles by clicking on “Start Here” link 1110. List 1108 of prefiltered profiles includes a name for each prefiltered profile group, a number of user profiles within each group, and an average CPM bid for the user profiles in the prefiltered group.

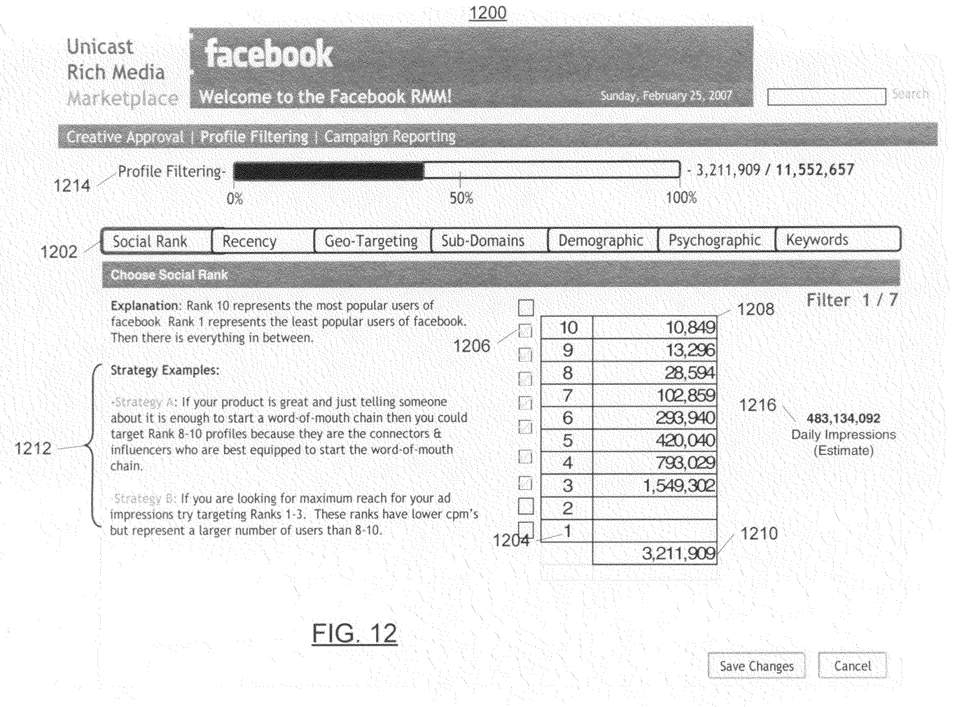

Choosing to create a new filtered selection of user profiles, the marketer clicks on Start Here link 1110 and proceeds to screenshot 1200 shown in FIG. 12. A first filter available to the marketer is Social Rank filter 1202. Social Rank filter 1202 allows a marketer to select user profiles with a specific social rank 1204 assigned. The marketer selects one or more social ranks 1204 by clicking on one or more boxes 1206. Marketplace application 512 then transmits the marketer's selection(s) to ad targeting system 102 (see FIG. 1), which implements the selections into filtering and targeting application 112 (see FIG. 1) to filter through the available pool of FACEBOOK user profiles using processes 300 depicted in FIG. 3. Results of the filtering process then are transmitted back to marketplace application 512 for display to the marketer in column 1208, where the number of FACEBOOK user profiles for each social rank 1204 are shown. The total number of user profiles selected once the marketer has completed choosing the desired social ranks is shown in section 1210. Helpful strategies to assist the marketer in choosing social ranks are provided at section 1212.

As the marketer enters the social rank selections, marketing application 512 updates Profile Filtering status bar 1214 to reflect the current percentage and number of user profiles now available after the social rank filter is applied. For example, after selecting user profiles with social ranks 1204 of 3 through 10, the number of user profiles with those social ranks is 3,211,909 out of the total number of FACEBOOK user profiles, which is 11,552,657. Additionally, marketing application 512 updates Daily Impressions display 1216 to reflect the estimated number of impressions, over a given time period, the marketer can expect for each of the now-filtered selection of user profiles. Once complete, the marketer saves any selections or entries made and proceeds to another filtering screen. Alternatively, the marketer is finished with selecting user profiles and does not apply any further filters.

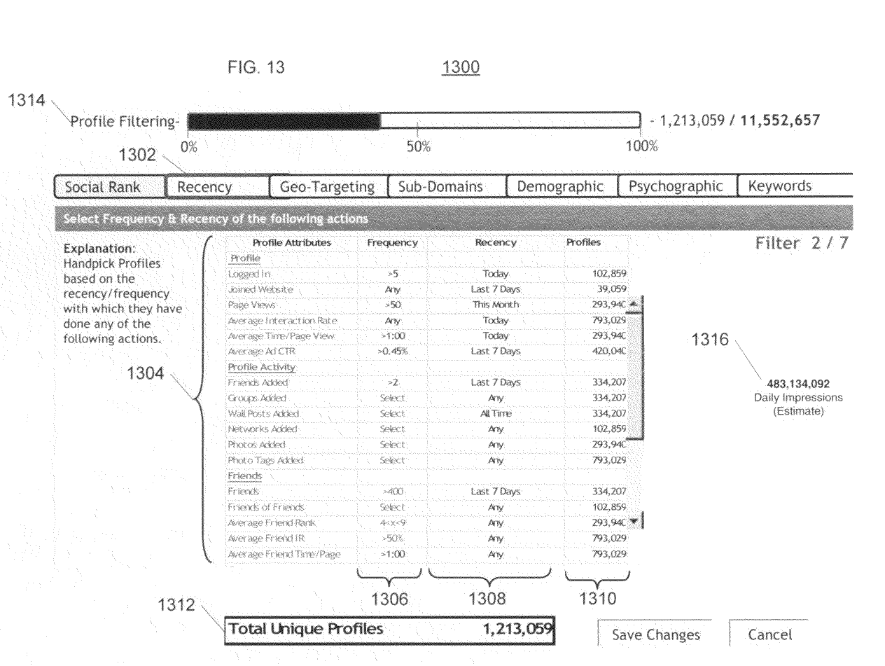

FIG. 13 shows screenshot 1300 of a second filter, Recency filter 1302, where “recency” is defined as a measure of occurrences of a certain activity performed by a user profile owner within the social network. In screenshot 1300, the marketer may select user profiles with specific attributes 1304 based on frequency column 1306 associated with each attribute 1304, recency column 1308 associated with each attribute 1304, and number of profiles column 1310 to which each attribute 1304 is applicable.

For example, a marketer who wishes to deliver an ad campaign for digital cameras may select user profiles depending on how frequently and how recently an associated user profile owner has added a photo to the owner's profile webpage. The marketer would then select the “Photos Added” attribute in Profile Attributes column 1304, would select or enter a number of photos added in Frequency column 1306, and would select how recent the photos would have been added to a user profile in Recency column 1308. Based on the marketer's selections, the total number of user profiles falling into the Photos Added attribute category with the specifics provided by the marketer would appear in column 1310.

As the marketer enters the selections, marketplace application 512 transmits the recency selections to ad targeting system 102, which implements the selections into filtering and targeting application 112. Application 112 applies a recency filter to the available pool of user profiles, incorporating the marketer's selections, and produces a filtered selection of user profiles that is transmitted to marketplace application 512 for display to the marketer in column 1310. Depending on other profile attributes 1304 selected, the total number of user profiles meeting the attribute selections appears in display 1312. Marketplace application 512 updates Profile Filtering status bar 1314 to reflect the current percentage and number of user profiles now available after the recency filter is applied. For example, after the recency filter is applied, the number of filtered user profiles is 1,213,059 out of the total number of 11,552,657 user profiles. Further, marketplace application 512 updates Daily Impressions display 1316 to reflect the estimated number of impressions the marketer can expect from the now-filtered selection of user profiles. Once complete, the marketer saves any selections or entries made and proceeds to another filter. Alternatively, the marketer is finished with selecting user profiles and does not apply any further filters.

The third filter available to the marketer is Geo-Targeting filter 1402 using screenshot 1400 in FIG. 14. Here, the marketer can target user profile owners in one or more specific geographic locations by selecting and/or entering one or more of a country, a region, a city, a zip code or global positioning coordinates (GPS) in section 1404. As the marketer enters his or her selections, marketplace application 512 transmits the geo-targeting selections to ad targeting system 102, which implements the selections into filtering and targeting application 112. Application 112 applies the geo-targeting filter 220 (see FIG. 2) to the available pool of user profiles and produces a filtered selection of user profiles that is sent to marketplace application 512. Once the filtered results are received by marketplace application 512, application 512 updates Profile Filtering status bar 1406 to reflect the current percentage and number of user profiles now available after the geo-targeting filter 220 has been applied. For example, after the geo-targeting filter is applied, the number of filtered user profiles is 1,001,583 out of the total number of 11,552,657 user profiles. Additionally, marketing application 512 updates Daily Impressions display 1408 to reflect the estimated number of impressions the marketer can expect from the now-filtered selection of user profiles. Once complete, the marketer saves any selections or entries made and proceeds to another filter. Alternatively, the marketer is finished with selecting user profiles and does not apply any further filters.

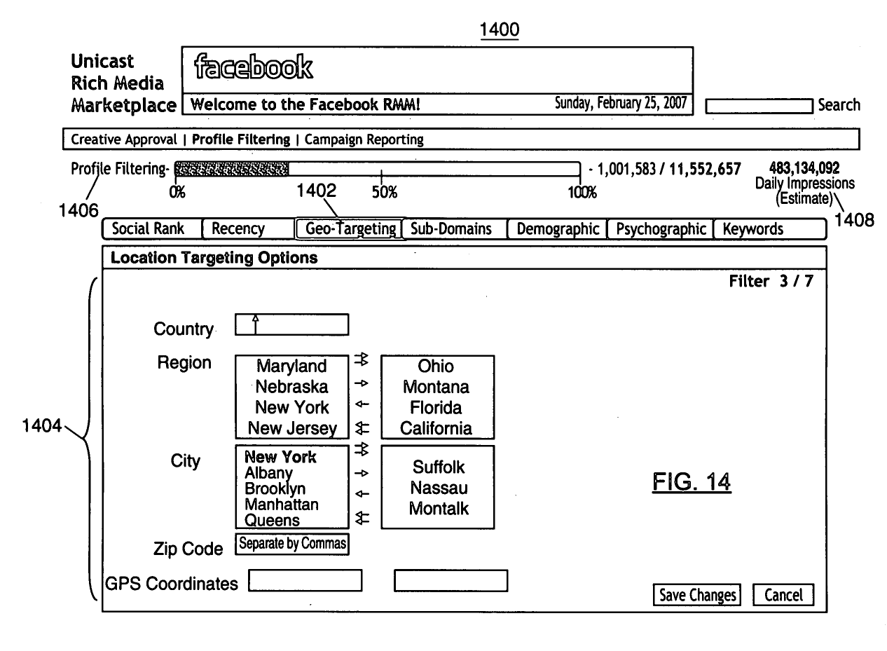

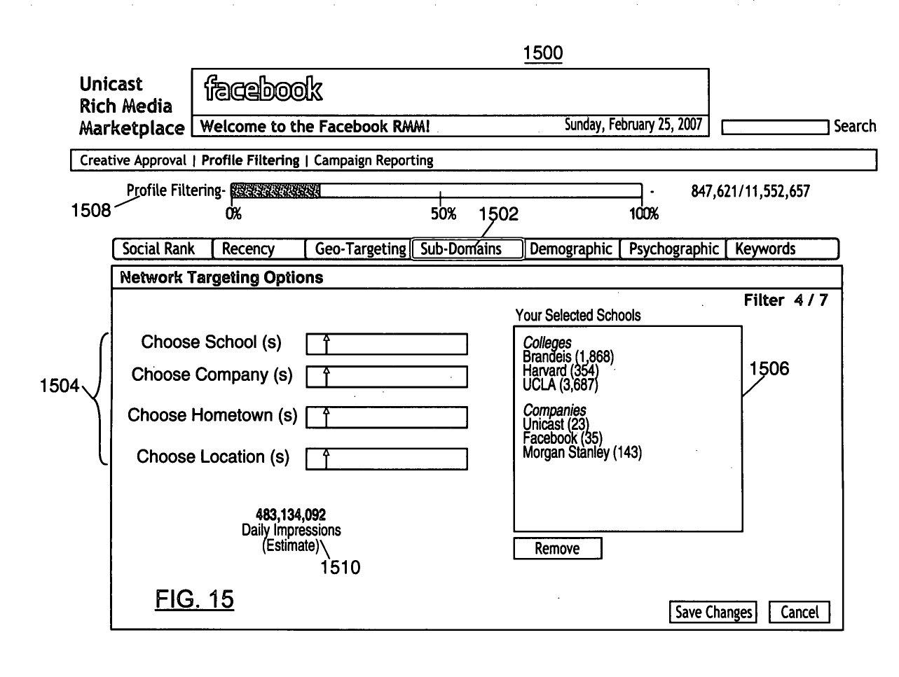

The marketer then proceeds to screenshot 1500 in FIG. 15, where Sub-domain filter 1502 is presented. The marketer uses filter 1502 to select user profiles with specific sub-domain attributes and/or attribute values. Examples of sub-domain attributes illustratively include a school a user profile owner has attended, a company a profile owner works for or has worked for, a hometown of a profile owner, and the current physical location of a profile owner. The marketer enters selections for sub-domains in section 1504. As the marketer enters the selections, marketplace application 512 transmits the sub-domain selections to ad targeting system 102, which implements the selections into filtering and targeting application 112. Application 112 applies sub-domain filter 228 (see FIG. 2) to the available pool of user profiles, and produces a filtered selection of user profiles that is transmitted to marketplace application 512.

Once the filtered results are received by marketplace application 512, the sub-domain entries appear in section 1506, which also shows the number of selected user profiles falling within each selected or entered sub-domain category. Additionally, marketplace application 512 updates Profile Filtering status bar 1508 to reflect the current percentage and number of user profiles now available after the sub-domain filter 228 has been applied. For example, after the sub-domain filter is applied, the number of filtered user profiles is 847,621 out of the total number of 11,552,657 user profiles. Further, marketing application 512 updates estimated Daily Impressions marker 1510 to reflect the estimated number of impressions the marketer can expect from the now-filtered selection of user profiles. Once complete, the marketer saves any selections or entries made and proceeds to another filter. Alternatively, the marketer is finished with selecting user profiles and does not apply any further filters.

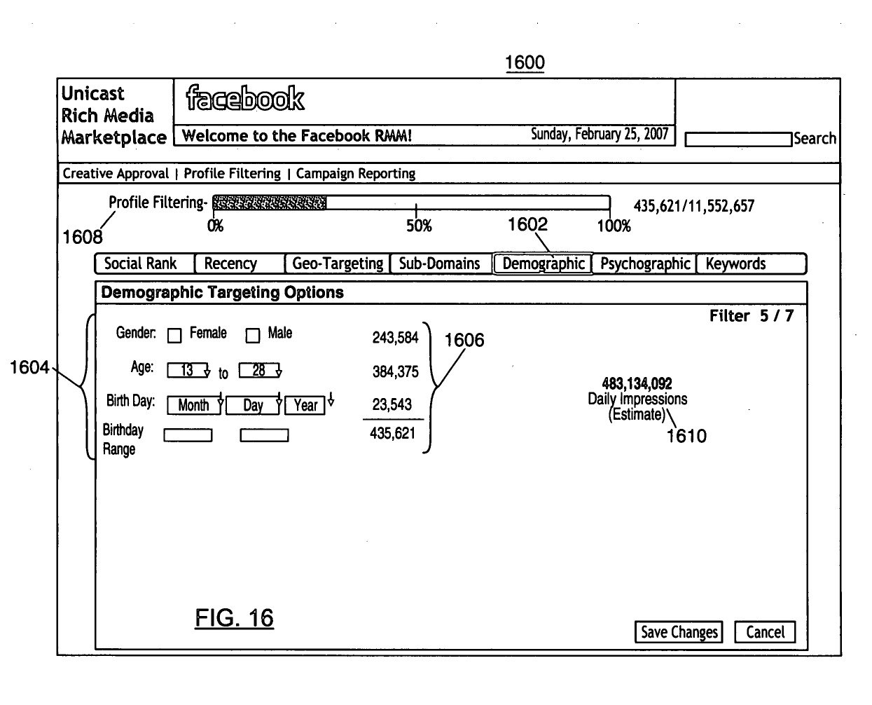

FIG. 16 is a screenshot 1600 of Demographic filter 1602 provided by marketing application 512 to the marketer. Here, the marketer filters the pool of available user profiles by selecting certain demographic attributes 1604, including, for example, a gender of a user profile owner, an age range for a profile owner, the date of birth of a profile owner, a personal income associated with a profile owner, and/or a birthday range of a profile owner, such as user profile owners with birthdays between January and March of a given year. The number of user profiles that fall within each demographic category is shown at section 1606. As the marketer enters the selections, marketplace application 512 transmits the demographic selections to ad targeting system 102, which implements the selections into filtering and targeting application 112. Application 112 applies the demographic filter 1602 to the available pool of user profiles and produces a filtered selection of user profiles. This selection is then transmitted to marketplace application 512 for display to the marketer in section 1606.

Once the filtered results are received by the marketplace application 512, application 512 updates Profile Filtering status bar 1608 to reflect the current percentage and number of user profiles now available after demographic filter 1602 has been applied. For example, after the demographic filter is applied, the number of filtered user profiles is 435,621 out of the total number of 11,552,657 user profiles. Further, marketing application 512 updates Daily Impressions marker 1610 to reflect the estimated number of impressions the marketer can expect from the now-filtered selection of user profiles. Once complete, the marketer saves any selections or entries made and proceeds to another filter. Alternatively, the marketer is finished with selecting user profiles and does not apply any further filters.

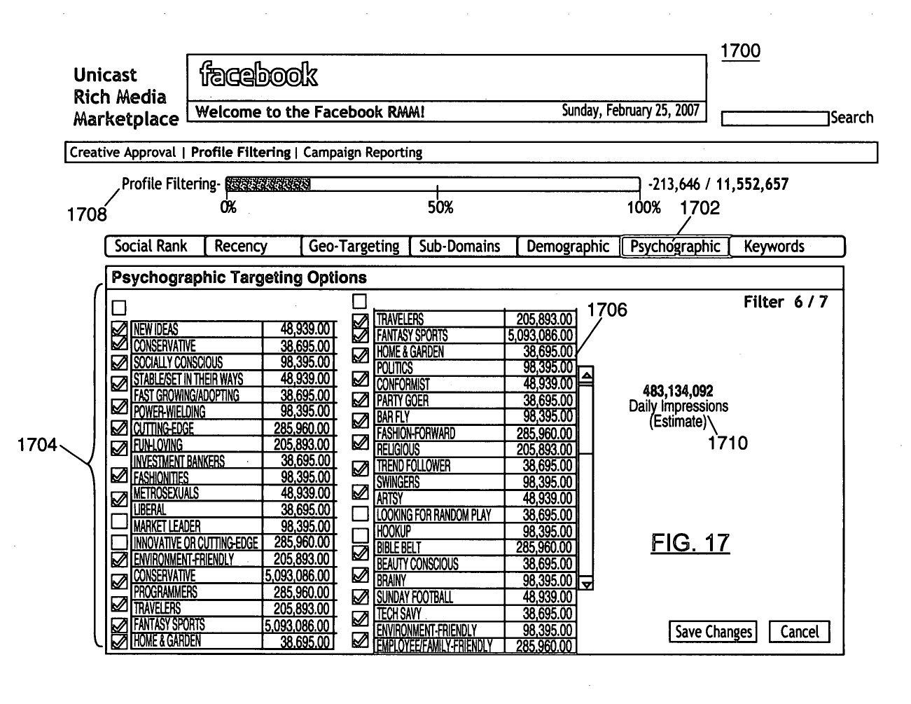

FIG. 17 shows screenshot 1700 of Psychographic filter 1702 for selecting user profiles based on lifestyle, interests, beliefs, values, opinions, and other personal attributes. On screenshot 1700, the marketer selects attributes in section 1704 to target user profiles by applying the psychographic filter depicted in process 400 in FIG. 4. As the marketer enters the selections in section 1704, marketplace application 512 transmits the psychographic attribute selections to ad targeting system 102, which implements the selections into filtering and targeting application 112. Application 112 applies the psychographic filter depicted in process 400 to the available pool of user profiles and produces a filtered selection of user profiles that is sent to marketplace application 512 for display to the marketer.

Once the filtered results are received by marketplace application 512, the number of available filtered user profiles associated with each psychographic attribute is shown in column 1706. Marketplace application 412 also updates Profile Filtering status bar 1708 to reflect the current percentage and number of user profiles now available after the psychographic filter is applied. For example, after the psychographic filter is applied, the number of filtered user profiles is 213,646 out of the total number of 11,552,657 user profiles. Further, marketing application 512 updates Daily Impressions display 1710 to reflect the estimated number of impressions the marketer can expect from the now-filtered selection of user profiles. Once complete, the marketer saves any selections or entries made and proceeds to another filter. Alternatively, the marketer is finished with selecting user profiles and does not apply any further filters.

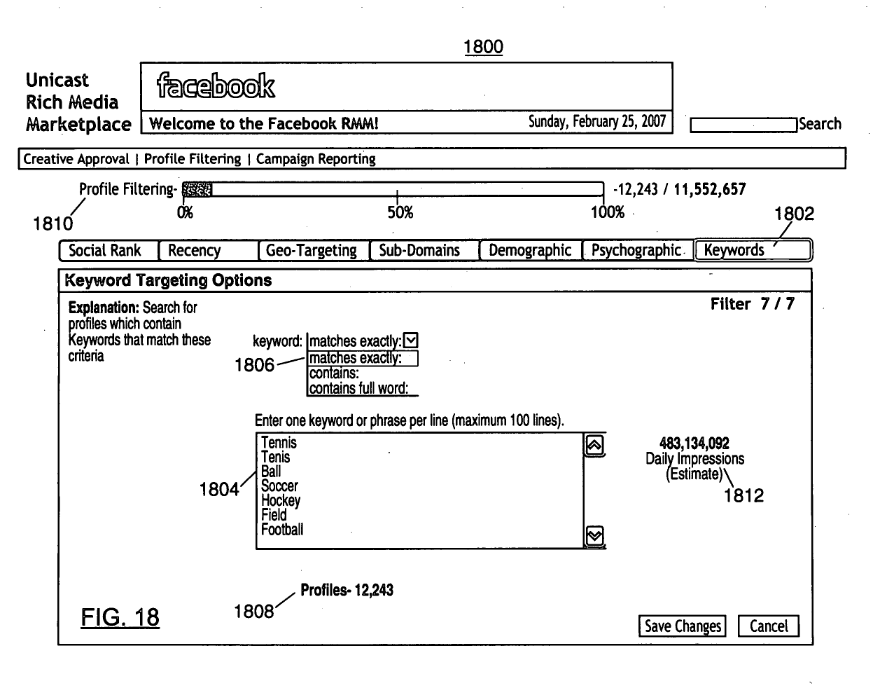

FIG. 18 shows screenshot 1800 of keyword filter 1802 provided by marketplace application 512 to the marketer. Here, the marketer can enter keywords or key phrases into section 1804 to select user profiles with those keywords or phrases stated on the profile webpage. Depending on how many user profiles the marketer wishes to reach, in section 1806 the marketer can choose how many of the terms should be included in a profile, whether the keywords or phrases search be exactly as entered into section 1804, or other rules applicable for searching the user profile. The marketer also can enter negative keywords in section 1804, where if a negative keyword is found on a user profile, that user profile should be excluded from selection.

As the marketer enters the keywords and phrases, marketplace application 512 transmits the keyword and negative keyword selections and entries to ad targeting system 102, which implements the keyword selections and entries into filtering and targeting application 112. Application 112 applies keyword filter 212 (see FIG. 2) to the available pool of user profiles and produces a filtered selection of user profiles that is sent to marketplace application 512 for display to the marketer at display 1808.

Once the filtered results are received by the marketplace application 512, application 512 updates Profile Filtering status bar 1810 to reflect the current percentage and number of user profiles now available after the demographic filter is applied. Marketplace application 512 also updates Daily Impressions display 1812 to reflect the estimated number of impressions the marketer can expect from the now-filtered selection of user profiles. Once complete, the marketer saves any selections or entries made and proceeds to another filter. Alternatively, the marketer is finished with selecting user profiles and does not apply any further filters. In another embodiment, the marketplace application 512 generates lists of popular keywords and phrases and presents these to the marketer for selection.

After applying one or more of the desired filters shown in FIGS. 12-18, the marketplace application generates a final selection of available user profiles meeting the desired criteria of the marketer. Now, the marketer can determine what ad campaign should be delivered to the selected user profiles and also can determine what CPM (cost per one thousand impressions) bid value should be entered for each of the user profiles for each ad campaign. Marketplace application 512 transmits the final selection of user profiles to ad management application 114 in ad targeting system 102 (See FIG. 1). Ad management application 114 then determines which of the marketer's ad campaigns would best serve the audience of selected user profiles. The marketer's ad campaigns are delivered to the owners of the selected user profiles so long as the marketer has the current highest CPM bid for each user profile. The marketer can manage his or her bidding for each ad campaign through the marketplace application 512, allowing the marketer to make changes to the CPM bids when desired.

Another embodiment includes a marketplace system for bidding on advertising rights to one or more user profiles where a bid is based on a cost-per-click “CPC” value of a specific ad campaign. Thus, a winning bid for delivering an ad campaign to a user profile webpage is based a combination of the bid amount and a historical click-thru-rate (“CTR) associated with the ad campaign.

Yet another embodiment includes a marketplace system for bidding on advertising rights to one or more user profiles based on a cost per acquisition “CPA” associated with an ad campaign. Thus, a winning bid for delivering an ad campaign to a user profile webpace is based on a combination of the bid amount and a historically high acquisition rate, where an acquisition is defined as a user profile owner making a purchase after clicking on an ad displayed from the ad campaign. Another embodiment includes a marketplace system for bidding on advertising rights to one or more user profiles based on a cost per day “CPD” of a particular ad campaign. Alternatively, the bid cost can include sharing a percentage of revenue generated by an ad campaign with a user profile owner, thereby motivating the owner to voluntarily influence the purchasing decisions of visitors to the owner's profile webpage and discuss the marketer's products shown in the displayed advertisements.

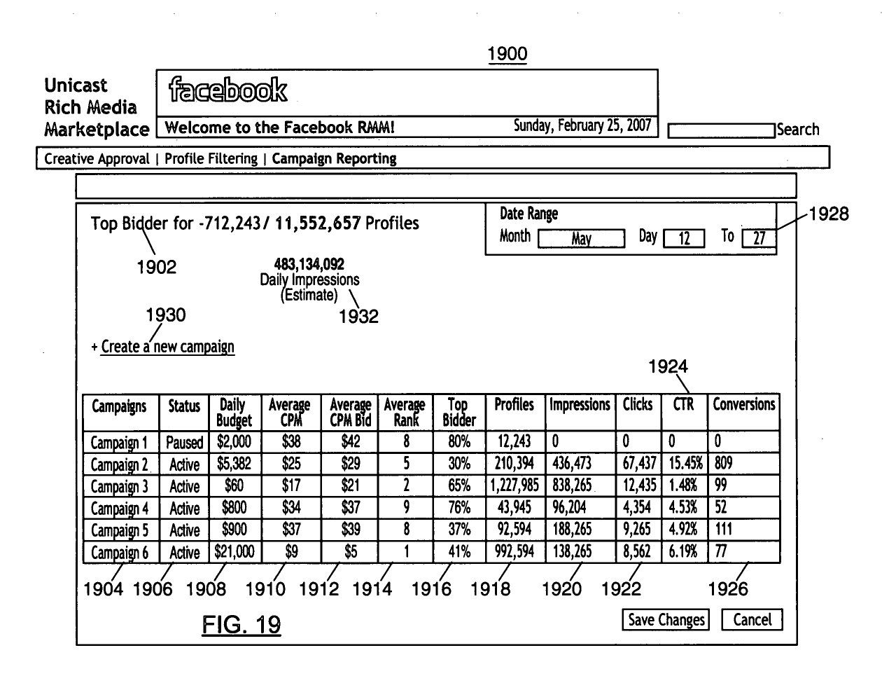

FIG. 19 shows screenshot 1900 from marketplace application where the marketer manages his or her ad campaigns. Screenshot 1900 includes display 1902 of user profiles for which the marketer has the top CPM bid out of the pool of the previously selected user profiles and a display 1932 of daily impressions estimated for each of the user profiles for which the marketer is the top CPM bidder. The marketer may also create a new ad campaign by clicking on the “+Create a new campaign” link 1930. The campaign information provided on screenshot 1900 for selected date range 1928 includes campaign name 1904, current status 1906 of each ad campaign, that is, whether a specific ad campaign is active and running, or paused, daily budget 1908 allotted for each ad campaign, average CPM value 1910 for the user profiles selected for each ad campaign, and average CPM bid 1912 among the user profiles selected for each ad campaign.

The marketer also can view average social rank value 1914 for the group of user profiles associated with each ad campaign, percentage 1916 of the group of user profiles selected for each ad campaign for which the marketer currently has the highest CPM bid, total number 1918 of profiles in the user group selected for each ad campaign, the total number of impressions 1920 for the ad campaign, meaning the total number of times the ad campaign has been displayed to the selected user profiles, number 1922 of clicks recorded from the selected group of user profiles for an ad campaign, click-through-rate (CTR) 1924 for each ad campaign, and total number 1926 of conversions for each ad campaign. Impressions data 1920 also may include sustained impressions, where a sustained impression accounts for the length of time an advertisement within an ad campaign is viewed.

For example, the marketer can view that the ad campaign, Campaign 2, is currently active and running, has an allotted daily budget of $5,382 for the CPM bids currently in place, has a current average CPM value of $38 per user profile with the current average CPM bid of $29 per user profile, previously placed by the marketer. The average social rank of the user profiles selected for Campaign 2 is 5 and the marketer currently is the top CPM bidder for only 30 percent of the 210,394 user profiles selected to receive the ads in Campaign 2. Further, Campaign 2 has provided 436,473 impressions of the ads to the selected user profiles during the selected date range but has received only 67,437 clicks on the delivered ads for a CTR of 15.45%. The number of conversions for the ads in Campaign 2 is 809.

In screenshot 1900, marketplace application 512 can indicate to the marketer where the marketer may wish to modify his or her CPM bids for the user profiles selected for an ad campaign. For example, where the marketer currently is the top CPM bidder for a high percentage of the selected user profiles, such as the 80% Top Bidder value 1916 for Campaign 1, marketplace application 512 can display the 80% box as green to indicate that the marketer is the top bidder for the majority of the user profiles, compared to other marketers CPM bids. What percentage is determined to be “high” may be predetermined by marketplace application 512, or may be previously set by the marketer. For example, the marketer can select to be notified to alter the CPM bids for a specific campaign when his or her percentage as the top bidder falls below 70% and below 50%. Using these preset limits, when the marketer is the top CPM bidder for less than 70% of the selected user profiles but is the top bidder for greater than 50% of the user profiles for an ad campaign, marketplace application 512 can display associated Top Bidder values 1916 as yellow, such as the value of 65% for Campaign 3. When the marketer is the top CPM bidder for less than 50% of the selected user profiles in an ad campaign, marketplace application 512 can display associated Top Bidder value 1916 as red, such as the value of 30% for Campaign 2. The marketer can then alter the average CPM bid 1910 for an ad campaign on screenshot 1900. This is just one example of how a marketplace application can display to the marketer where action should be taken.

Alternatively, a marketplace application, such as the application 512 depicted in FIG. 5, provides for a marketer to enter an average CPM bid for each type of ad format used in a given ad campaign. For example, if an ad campaign contains both banner type ads and newsfeed type ads, the marketer may customize the CPM bid values to each of the ad types, depending on the performance of each ad type on a user profile webpage.

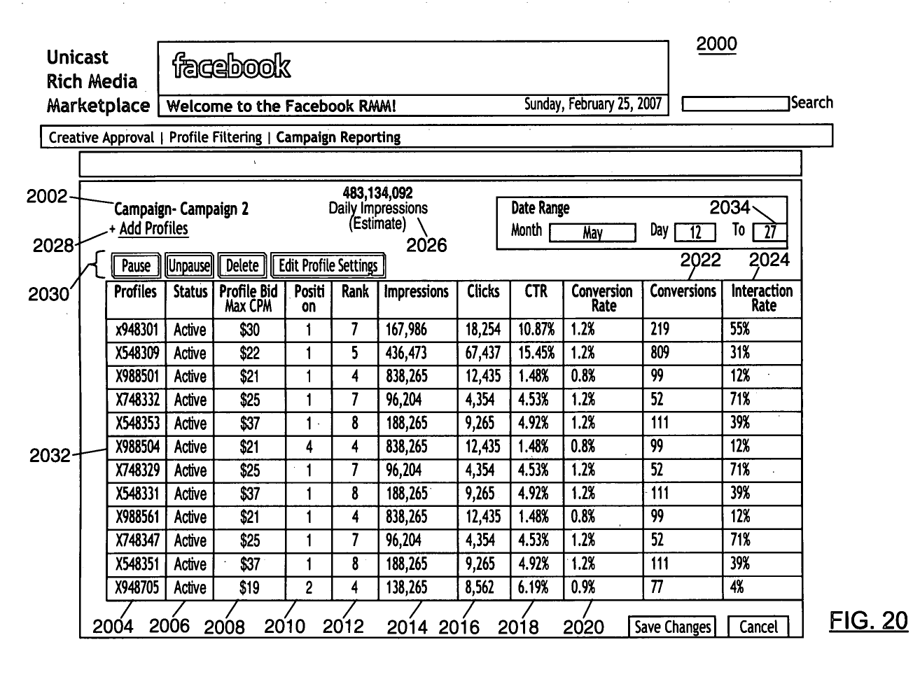

The marketer also can select to view the details underlying a specific ad campaign displayed on screenshot 1900 by clicking on ad campaign name 1904. For example, when the marketer clicks on ad campaign name 1904 “Campaign 2,” the marketer proceeds to screenshot 2000 in FIG. 20.

Screenshot 2000 in FIG. 20 displays the individual user profile details for each of the user profiles selected for a specific ad campaign, namely Campaign 2. Screenshot 2000 includes profile identification number 2004 for each user profile, where an identification number is used to protect the personal details of a user profile owner, status 2006 of each user profile, that is, whether the user profile is currently receiving ads for display, maximum CPM bid 2008 placed by the marketer for each user profile, marketers bidding position 2010, that is, the top bidder, the second top bidder, and the like, relevant to other marketers also bidding on a user profile, and social rank 2012 of each of the user profiles, as generated by ad targeting system 102 using social rank process 300 depicted in FIG. 3.

Screenshot 2000 also provides the number of ad impressions 2014 recorded for each of the profiles in the given time period 2036, the number of clicks 2016 received on the ads displayed on the profile page, the CTR 2018 for each profile in the given time period 2004, the conversion rate 2020 for the ads displayed on the profile, the total number of conversions 2022 in the given time period 2004, and an Interaction Rate 2024 for each profile, where the Interaction Rate 2024 represents the frequency of visitors to the profile page within the given time period 2004.

If desired, the marketer may alter maximum CPM profile bid 2008 for any of listed user profiles 2004. To assist the marketer, marketplace application 512 can suggest a CPM bid amount based on the current activity of a user associated with a selected user profile. Additionally, marketplace application 512 can indicate where maximum CPM bid 2008 should be modified based on marketer's position 2010 relevant to other marketers bidding on the same profile by shading position 2010 a color, such as red. Thus, when the marketer initially views screenshot 2000, the marketer immediately sees where bidding changes should be made to obtain the top bidding position for a specific user profile. For example, for top bidding position 2010 of “4” for Profile X988504, shown at 2032, marketplace application 512 can shade position 2010 to red to emphasize that the ads in Campaign 2 are not being shown to Profile X988504 shown at 2032 until after the top three bidding marketers' ads campaigns become inactive or paused. Thus, the marketer should increase maximum CPM bid 2008 from $21 for Profile X988504 shown at 2032 until associated position 2010 indicates that the marketer is the top bidder for that profile by displaying a “1.”

The marketer may also Pause, Unpause, Delete or Edit the other settings of user profile 2004 by selecting one of buttons 2030, and then clicking on a user profile name within column 2004. Further, the marketer may add new profiles to Campaign 2 by clicking on the “Add Profiles” link 2028. Once finished utilizing screenshot 2000, the marketer may save or cancel any changes made by selection one of buttons 2034.

Although the invention has been described in conjunction with an online social network, the invention also encompasses delivering targeted advertisements to a user as the user navigates to other non-social network Internet websites. In another embodiment of the present invention, a system is provided for integrating analytics data gathered from user activity on a non-social network website with a targeted ad campaign. This system, such as system 100 shown in FIG. 1, includes a marketplace application, such as application 512 shown in FIG. 5, where the marketer can manage an ad campaign delivered to a user when the user visits other websites outside of a social network. Further, this system provides for the marketer to enter different CPM bids for each type of website visited by the user. For example, a marketer may enter a first CPM bid of $20 for displaying ads to a user when the user visits a news website, a second CPM bid of $15 for ads to be delivered to a search engine website when visited by the same user, and a third CPM bid of $30 for ads displayed on the user's profile webpage within a social network.

Analytics data from the non-social network website can be obtained by ad targeting system 102 for a website requiring a user to log into a saved user profile, such as, for example, a chatroom forum website. Analytics data also can be obtained from a website where no login of the user profile is required, such as a news website. For a website requiring login by the user profile, an embodiment of the present invention includes an ad targeting system, such as ad targeting system 102 shown in FIG. 1, for obtaining analytics data for each login user profile and generating a profile rank for each login profile, similar to social rank process 300 (see FIG. 3), based on the profile's behavioral and activity recorded on the website.

Alternatively, analytics data can be obtained from a non-login website by collecting data for each individual webpage within the website and generating a ranking of value of each webpage within the no-login website, similar to social rank 300 (see FIG. 3) based on behavior analytics for each webpage. For example, ad placement on a homepage of a website may have a higher rank than other pages of the website if a user spends more time on the homepage compared to time spent viewing the other webpages. Ad placement on the homepage can have a high rank due to the user viewing the homepage more frequently than other webpages within the website. The user's activity thus generates a higher advertisement click-thru-rate “CTR” for the homepage compared to the other webpages in the website.

Further, a user may place a web widget from a social network, or other third party website, onto the non-social network website. In doing so, an ad targeting system may deliver ads for display in the web widget, where the ads are selected based on analytics data from the web widget homesite, obtained for the specific user. A web widget illustratively includes mobile widgets and desktop widgets.

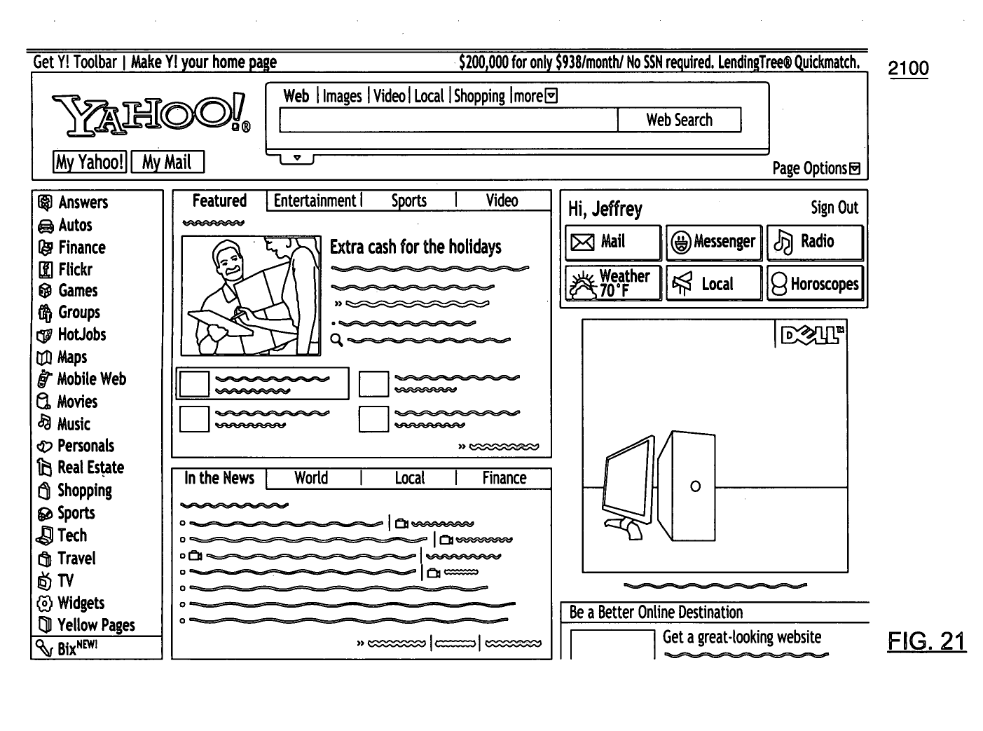

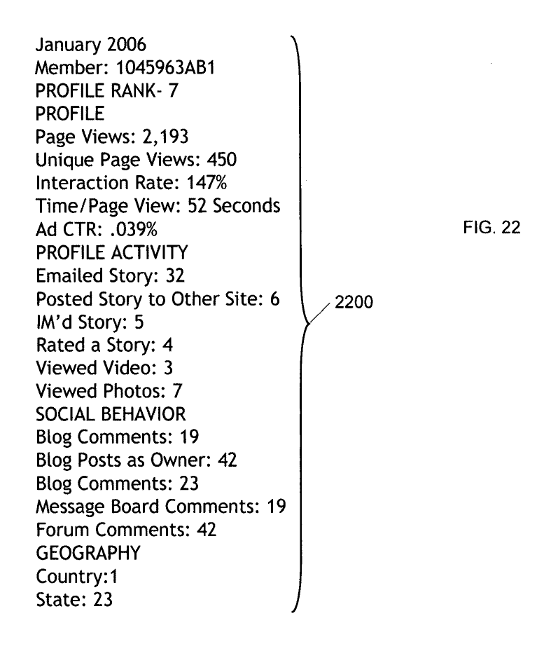

FIG. 21 provides screenshot 2100 of a homepage providing a login to a non-social network website, www.yahoo.com, for a user named Jeffrey. The Yahoo!® webpage 2100 contains selections to view news content, weather content, entertainment content, sports content, e-mail, and the like. A sample of analytics data associated with Jeffrey's profile on the Yahoo website is shown in FIG. 22 as data 2200.

Data 2200 includes data similar to data available from a user profile in a social network, such as the data displayed in Table 1, for example, Profile data, Profile Activity data, and Geography data. However, analytics data 2200 is custom to Jeffrey's activity on his Yahoo homepage 2100. For example, Profile Activity data in data 2200 describes actions performed by Jeffrey on Yahoo homepage 2100, including videos viewed, Yahoo content emailed to other user profiles, and Yahoo content posted to another website outside of the Yahoo website. Analytics data 220 also includes Jeffrey's activity on other webpages within the Yahoo website, such as on blogs, message boards, and chatroom forums.

A marketer who wishes to target an ad campaign to Jeffrey based on analytics data 2200 in FIG. 22 would use an ad targeting system, such as ad targeting system 102 shown in FIG. 1, to process data 2200 and generate a profile rank using social rank process 300 depicted in FIG. 3. Jeffery's profile rank is relative to other users who maintain profiles in the Yahoo website. The computed profile rank value for Jeffrey is a “7” out of 10, as shown in analytics data 2200 in FIG. 22. The profile ranks of other user profiles on Yahoo are also generated using the ad targeting system. A marketer could then select desired user profiles from the Yahoo website for displaying an ad campaign using a marketing application, such as marketing application 512 depicted in FIG. 5. The marketer would apply one or more filters to the Yahoo profiles, similar to the filtering process depicted in FIGS. 6-20, but customized for the profiles in the Yahoo website network.

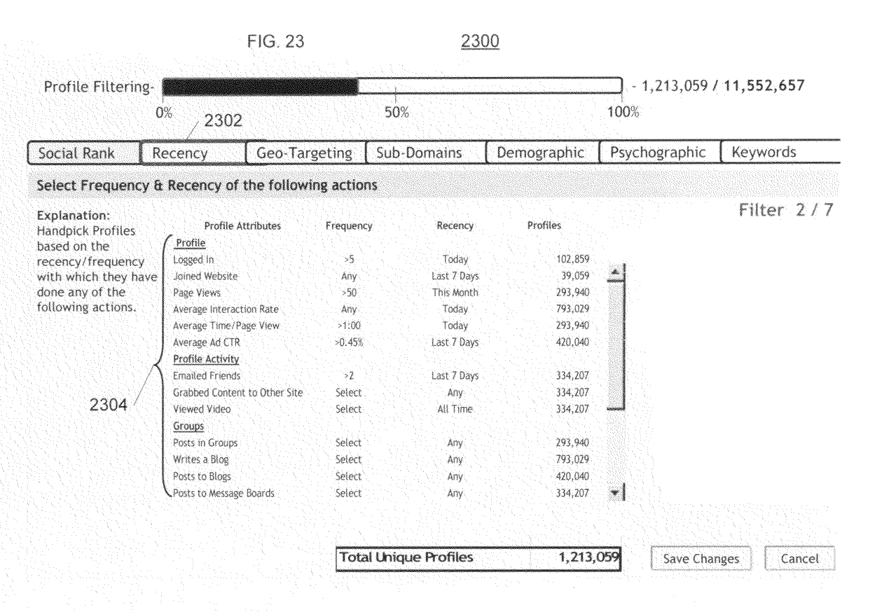

For example, FIG. 23 shows screenshot 2300 of Recency filter 2302 available to the marketer. Although screenshot 2300 is similar to screenshot 1300 shown in FIG. 1300, Profile Attributes 2304 are customized for analyzing the attributes of a user's activity, such as Jeffrey's activity, within the Yahoo!® website. Profile Attributes 2304 illustratively include “Emailed Friends,” which represents how often a user emails other users from his or her Yahoo email account, “Viewed video,” which represents how often and how recent a user has viewed videos offered on the Yahoo webpages, and “Posts to Blogs,” which represents how often and how recent a user posts messages on one or more blogs contained on the Yahoo webpages.

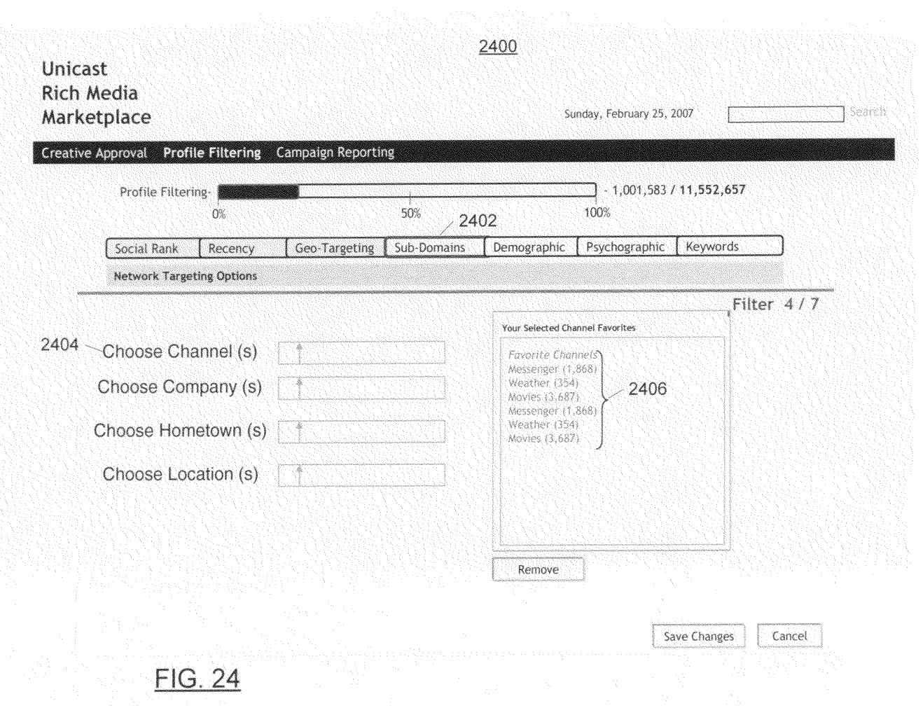

FIG. 24 shows screenshot 2400 of Sub-domain filter 2402 available to the marketer. Screenshot 2400 is similar to Sub-domain screenshot 1500 shown in FIG. 15, however, screenshot 2400 is customized for filtering through user profiles from the Yahoo website network. Such customization includes displaying a selection 2404 for choosing channels in the Yahoo website visited by the user profiles, compared to choosing schools in section 1504 on screenshot 1500 of user profiles in a social network. Similar to screenshot 1500, the entries made by a marketer on screenshot 2400 are displayed in section 2406.

Once the marketer completes the process of filtering through user profiles on a non-social network website, such as Yahoo, the marketer may manage his or her ad campaigns targeted to one or more of the selected user profiles using the marketplace application, similar to marketplace application 512 shown in FIG. 5, and using an ad targeting system, similar to ad targeting system 102 depicted in FIG. 1.

Although various embodiments which incorporate the teachings of the present invention have been shown and described in detail herein, those skilled in the art can readily devise many other varied embodiments that still incorporate these teachings.

I claim:

1. A method for filtering through a plurality of online users using psychographic data obtained from related user profiles within an online social network, in order to identify online users with similar behavioral interests, comprising the steps of:
obtaining psychographic data from each user profile;
generating a list of psychographic categories;
generating a list of keywords associated with each psychographic category;
generating a list of website addresses related to the psychographic categories;
searching through a webpage associated with each website address from the website list using the keyword list;
generating a matrix comprising keywords found, a frequency of each keyword found, and website addresses having the keywords;
applying a clustering algorithm to the matrix to generate a plurality of keyword clusters, wherein each keyword cluster represents a group of webpages that are statistically similar to each other based on the keywords each webpage contains;
assigning each keyword cluster to a first psychographic category from the category list;
searching through the user profiles using the plurality of keyword clusters; and
assigning each user profile to a second psychographic category from the category list.

2. The method recited in claim 1 wherein the psychographic data comprises behavioral characteristics data relating to personality, values, attitudes, interests and lifestyles of each online user.

3. The method recited in claim 1 further comprising the step of generating a list of stopwords prior to the step of searching through a webpage, wherein the stopwords list comprises words to be ignored during the searching step.

4. The method recited in claim 1 wherein the step of searching through a webpage further comprises crawling each webpage using a web crawling application.

5. The method recited in claim 1 wherein the step of searching through a webpage further comprises the steps of:
identifying a keyword from the keyword list on the searched webpage;
recording the website address of the searched webpage; and
recording the frequency of the keyword on the searched webpage.

6. The method recited in claim 1 wherein the step of searching through a webpage further comprises the step of selecting hyperlinks on a searched webpage to connect to another webpage.

7. The method recited in claim 1 wherein the step of searching through a webpage continues until a predetermined maximum value of searched webpages is reached.

8. The method recited in claim 1 wherein the step of searching through a webpage continues until a frequency of locating a keyword from the keyword list falls below a predetermined rate.

9. The method recited in claim 1 wherein the psychographic categories comprise types of movies, types of sports, work habits, and lifestyle interests.

10. The method recited in claim 1 wherein the clustering algorithm is selected from the group consisting of a singular value decomposition algorithm, a principal components analysis algorithm, a fast principal components analysis algorithm, a correlation computation algorithm, and a k-means algorithm.

11. The method recited in claim 1 wherein the step of assigning each user profile to a second psychographic category further comprises selecting user profiles containing a predetermined percentage of keywords.

12. The method recited in claim 1 wherein the step of searching through each user profile further comprises crawling each profile using a web crawling application.

13. The method recited in claim 1 further comprising the step of selecting user profiles based on a specific psychographic category to receive an advertising campaign targeted to the specific psychographic category.

14. A computer system for filtering through a plurality of online users using psychographic data obtained from related user profiles within an online social network, in order to identify online users with similar behavioral interests, comprising:
a central processing unit;
a set of support circuits; and
a server, wherein the server stores and maintains a memory comprising:
at least one operating system; and
a software application for generating the filter using psychographic data, wherein the software application comprises a plurality of modules, wherein the plurality of modules perform the following functions:
obtaining psychographic data from each user profile, wherein the psychographic data comprises behavioral characteristics data relating to personality, values, attitudes, interests and lifestyles of each online user;
generating a list of psychographic categories;
generating a list of keywords associated with each psychographic category;
generating a list of website addresses related to the psychographic categories;
searching through a webpage associated with each website address from the website list using the keyword list;
generating a matrix comprising keywords found, a frequency of each keyword found, and website addresses having the keywords;
applying a clustering algorithm to the matrix to generate a plurality of keyword clusters,
wherein each keyword cluster represents a group of webpages that are statistically similar to each other based on the keywords each webpage contains;
assigning each keyword cluster to a first psychographic category from the category list;
searching through the user profiles using the plurality of keyword clusters; and
assigning each user profile to a second psychographic category from the category list.
